(19) United States
(12) Patent Application Publication
(10) Pub. No.: US 2005/0101385 A1
(43) Pub. Date: May 12, 2005

(54) Gaming system and gaming machine therefor

(75) Inventor: Katsuhiro Kido, Tokyo (JP)

Correspondence Address: ALFRED A. STADNICKI;ANTONELLI, TERRY, STOUT & KRAUS, LLP, SUITE 1800, 1300 North Seventeenth Street, ARLINGTON, VA, 22209, US

(73) Assignee: ARUZE CORPORATION, Tokyo (JP)

(21) Appl. No.: 10/812,973

(22) Filed: Mar. 31, 2004

(30) Foreign Application Priority Data
Apr. 7, 2003 (JP) 2003-103483

(51) Int. Cl. A63F 13/00

(52) U.S. Cl. 463/42; 463/20

(57) ABSTRACT

A gaming system and a gaming machine, in which a player of a first game can participate in a second game having different game contents without moving between gaming machines. In the gaming system and the gaming machine, a first gaming machine is provided with a second display different from for the first game and connected communicatively with a second gaming machine, and has functions: to transmit/receive information on the second game controlled by the second gaming machine; and to allow the player to perform the second game in the second display on the basis of the information of the second game.

### CROSS-REFERENCE TO RELATED APPLICATION

This application is based upon and claims the benefit of priority from the prior Japanese Patent Application No. 2003-103483 filed on Apr. 7, 2003, the entire contents of which are incorporated herein by reference.

### FIELD OF THE INVENTION

The present invention relates to a gaming system and a gaming machine therefor.

### RELATED ART

In a gaming place, various gaming machines such as a slot machine are installed, and a so-called “table game” such as poker, roulette, or keno game is played. Therefore, a player may get tired of playing only the slot machine continuously, for example, and may feel like playing another kind of game.

However, it is troublesome for the player to leave the slot machine and to participate in a game of different content with another gaming machine, which is installed another place. It is, therefore, difficult to keep the player playing the slot machine without being tired of it.

Therefore, a gaming machine has been proposed such that the gaming machine, in addition to a variable display for symbols of the slot machine, may have another display for a second game such as a bingo game where the player may play the bingo game utilizing numbers corresponding to respective symbols displayed in the variable display (referring to JP-A-11-253610 (Japanese unexamined patent publication No. H11-253610)).

However, the gaming machine fails to satisfy the desire of the player to play another kind of game of different contents. As a result, the gaming machine may also make the player tired of it.

For example, the player may feel like participating in other kinds of games with other gaming machines, which are installed in other places. The other kinds of games may include games being played with a plurality of players, such as a horse racing game, a roulette game, and a keno game. If these games are held at places different from where the slot machine is installed, however, the player would not rather feel like moving from the slot machine to other gaming machines, with which these games are played. Moreover, the game such as the horse racing, roulette, or keno game has a limit in the number of participants. Therefore, the player of the slot machine may be unable to participate in such games as the horse racing, roulette, and keno game, even if the player quits playing the slot game. Thus, the player may not easily participate in such games of different contents.

### SUMMARY OF THE INVENTION

According to the present invention, there is provided a gaming system or a gaming machine, in which a player who is playing a first game with a first gaming machine can participate in a second game of different contents from that of the first game without leaving the first gaming machine.

In the gaming system and gaming machine therefor, the first gaming machine is provided with a second display different from a variable display for displaying the first game and connected communicatively with a second gaming machine, and has functions: to transmit/receive information about the second game controlled by the second gaming machine; and to allow the player to play the second game with the second display on the basis of the information about the second game.

More specifically, the invention provides the following.
(1) There is provided a gaming system comprising: a first gaming machine for providing a first game, which includes a control panel to be operated by a first player; and a second gaming machine connected communicatively with the first gaming machine for providing a second game, which is different from the first game and in which another player in addition to the first player is capable of participating, wherein the second gaming machine comprises second game control means including: program storage means for storing a program to control the second game; program execution means for executing the program; image data storage means for storing image data of the second game; and image data transmission means for transmitting the image data of the second game to the first gaming machine, and wherein the first gaming machine comprises: first game control means for controlling the first game; image data reception means for receiving the image data of the second game transmitted from the second gaming machine; second display means for displaying an image based on the image data of the second game; and game operation means for operating the game control means of the second game.
(2) The gaming system according to (1) is characterized in that the first player operates the game operation means such that the first player bets for the second game.
(3) The gaming system according to (1) or (2) is characterized in that the first gaming machine comprises payout means for paying out to the first
(4) The gaming system according to any one from (1) to (3) is characterized in that the first game is played only by the first player.
(5) The gaming system according to any one from (1) to (4) is characterized in that the first gaming machine comprises first display means for variably displaying a plurality of symbols for the first game.
(6) The gaming system according to any one from (1) to (5) is characterized in that the first gaming machine comprises a video poker game.
(7) The gaming system according to any one from (1) to (6) is characterized in that the first and second gaming machines are connected through the Internet.
(8) The gaming system according to any one from (1) to (7) is characterized in that the second gaming machine transmits a starting signal to the first gaming machine such that the first player is invited to the second game.
(9) There is provided a first gaming machine for providing a first game, which includes a control panel to be operated by a first player; wherein the first gaming machine is connected communicatively with a second gaming machine for providing a second game, which is different from the first game and in which another player in addition to the first player is capable of participating, and wherein the first gaming machine comprises: first game control means for controlling the first game; image data reception means for receiving the image data of the second game transmitted from the second gaming machine; second display means for displaying an image based on the image data of the second game; and game operation means for operating game contents of the second game.
(10) The first gaming machine according to (9) is characterized in that the first player operates the game operation means such that the first player bets for the second game.
(11) The first gaming machine according to (9) or (10) is characterized in that the first gaming machine comprises payout means for paying out to the first player based on a result of the second game.
(12) The first gaming machine according to any one from (9) to (11) is characterized in that the first game is played only by the first player.
(13) The first gaming machine according to any one from (9) to (12) further comprises first display means for variably displaying a plurality of symbols for the first game.
(14) The first gaming machine according to any one from (9) to (13) is characterized in that the first gaming machine comprises a video poker game.
(15) The first gaming machine according to any one from (9) to (14) is characterized in that the first gaming machine is connected with the second gaming machine through the Internet.
(16) The first gaming machine according to any one from (9) to (15) is characterized in that the first gaming machine receives a starting signal from the second gaming machine such that the first player is invited to the second game.

According to the present invention, the first gaming machine comprises: first display means for variably displaying a plurality of symbols for the first game; image data reception means for receiving the image data about the second game transmitted from the second gaming machine; second display means for displaying an image based on the image data of the second game. Therefore, the player who is playing the first game is allowed to play a second game without moving to another gaming machine in case the player feels tired of playing the first game. If it is troublesome for the player to move to another gaming machine, the player may be discouraged to play the second game. However, the player who is playing the first game can participate in the second game without moving to any gaming machines installed in another place. The participation of the player in the second game can be promoted such that the player has more choices of games. Therefore, the gaming place may have high efficiency as a whole.

Moreover, it is possible to provide an opportunity to more players for participating in the second game.

Moreover, the first gaming machine may include game operation means for operating game contents of the second game. Therefore, the play can be operated with the first gaming machine although the second gaming machine controls the second game so that the player can change the contents of the second game at a place distant from the second gaming machine.

Moreover, the second gaming machine includes: program storage means for storing a program to control the second game; program execution means for executing the program; image data storage means for storing image data on the second game; and image data transmission means for transmitting the image data on the second game to the first gaming machine. Therefore, the second game need not be controlled by the first gaming machine so that the second game can be executed in the first gaming machine with the simple control structure.

If the gaming machines for the game, in which a plurality of players can participate, such as the horse racing, roulette, or keno game are arranged at places different from that of the slot machine, for example, the player of the slot machine feels troublesome in quitting the current game and leaving the current gaming machine when the player is to participate in the game such as horse racing, roulette, or keno game. Moreover, if the horse racing, roulette, or keno game has limits in the number of participants, the player of the slot machine may not be able to participate in such game. Even if the player intends to participate in such game, the participating timing may be limited. By making use of the invention, however, the player can be released from the troubles of moving between the gaming machines so that the player can easily participate in the game which accepts the plural participants. The player of the slot machine can participate in another game, if the player intends so, without moving between the gaming machines. Therefore, the participation of the player in the game, which admits the plural participants, such as the horse racing, roulette or keno game, can be promoted to improve the selectivity of any game admitting the plural participants, such as the slot game, or the horse racing, roulette or keno game, by the player, thereby to enhance the working efficiency of the entire gaming place.

Further features of the invention, its nature, and various advantages will be more apparent from the accompanying drawings and the following detailed description of the invention.

### BRIEF DESCRIPTION OF THE DRAWINGS

FIG. 1 is a network configuration diagram according to a first embodiment of the present invention.

FIG. 2 is a perspective view of a gaming machine 100 according to the first embodiment of the present invention.

FIG. 3 is a diagram showing a data table of the stop symbols of the gaming machine 100 according to the first embodiment of the present invention.

FIG. 4 is a diagram tabulating the winning stop modes and the numbers of corresponding prize coins of the gaming machine 100 according to the first embodiment of the present invention.

FIGS. 5A to 5C are diagrams schematically showing the turns and stops of the reels of the gaming machine 100 according to the first embodiment of the present invention.

FIG. 6 is a hardware block diagram of the gaming machine 100 according to the first embodiment of the present invention.

FIG. 7 is a schematic diagram showing a gaming machine 200 according to the first embodiment of the present invention.

FIG. 8 is a hardware block diagram of the gaming machine 200 according to the first embodiment of the present invention.

FIG. 9 is a flow chart showing a process in the gaming machine 100 according to the first embodiment of the present invention.

FIG. 10 is a flow chart showing a process in the gaming machine 100 according to the first embodiment of the present invention.

FIG. 11 shows flow charts of processes to be performed by the communications of the gaming machine 100 and a gaming machine 200 or 300 according to the first embodiment of the present invention.

FIG. 12 shows flow charts of processes to be performed by the communications of the gaming machine 100 and the gaming machine 200 or 300 according to the first embodiment of the present invention.

FIG. 13 shows flow charts of processes to be performed by the communications of the gaming machine 100 and the gaming machine 200, 300 or 500 according to the first embodiment of the present invention.

FIG. 14 shows flow charts of processes to be performed by the communications of-the gaming machine 100 and the gaming machine 200 according to the first embodiment of the present invention.

FIG. 15 is a display image diagram of a second game displayed in a second display device of the gaming machine 100 according to the first embodiment of the present invention.

FIG. 16 is a network configuration diagram according to a second embodiment of the present invention.

FIG. 17 is a perspective view of the gaming machine 300 according to the second embodiment of the present invention.

FIG. 18 is a hardware block diagram of the gaming machine 300 according to the second embodiment of the present invention.

FIG. 19 shows flow charts of processes to be performed by the communications of the gaming machine 100 and the gaming machine 300 according to the second embodiment of the present invention.

FIG. 20 is a display image diagram of the second game displayed in the second display device of the gaming machine 100 according to the second embodiment of the present invention.

FIG. 21 is a network configuration diagram according to a third embodiment of the present invention.

FIG. 22 is a perspective view of a gaming machine 400 according to the third embodiment of the present invention.

FIG. 23 is a hardware block diagram of the gaming machine 400 according to the third embodiment of the present invention.

FIG. 24 is a schematic diagram showing the gaming machine 500 according to the third embodiment of the present invention.

FIG. 25 is a hardware block diagram of the gaming machine 500 according to the third embodiment of the present invention.

FIG. 26 is a flow chart showing a process in the gaming machine 400 according to the third embodiment of the present invention.

FIG. 27 is a flow chart showing a process in the gaming machine 400 according to the third embodiment of the present invention.

FIG. 28 shows flow charts of processes to be performed by the communications of the gaming machine 400 and the gaming machine 500 according to the third embodiment of the present invention.

FIG. 29 is a display image diagram of the second game displayed in the second display device of the gaming machine 400 according to the third embodiment of the present invention.

FIG. 30 is a display image diagram of the second game displayed in the second display device of the gaming machine 100 or 400 according to a modified embodiment of the present invention.

FIG. 31 shows a perspective view of a slant type gaming machine according to a modified embodiment of the present invention and an image diagram of a physical addition of a system for a second game to the slant type gaming machine.

### DETAILED DESCRIPTION OF THE INVENTION

Three preferred embodiments of the present invention will be described with reference to the accompanying drawings.

The following embodiments will be described by using a “coin” as medium for representing a value in a game. However, any medium having the game value substituting the “coin”, such as “currency”, “token”, “game value information (credit) stored in a magnetic card or IC chip”, “game ball” and/or “medal”, may also be used.

### FIRST EMBODIMENT

The first embodiment is exemplified by using a “slot game” as the first game of the present invention and a “horse racing game” as the second game.

### NETWORK CONFIGURATION OF GAMING MACHINE

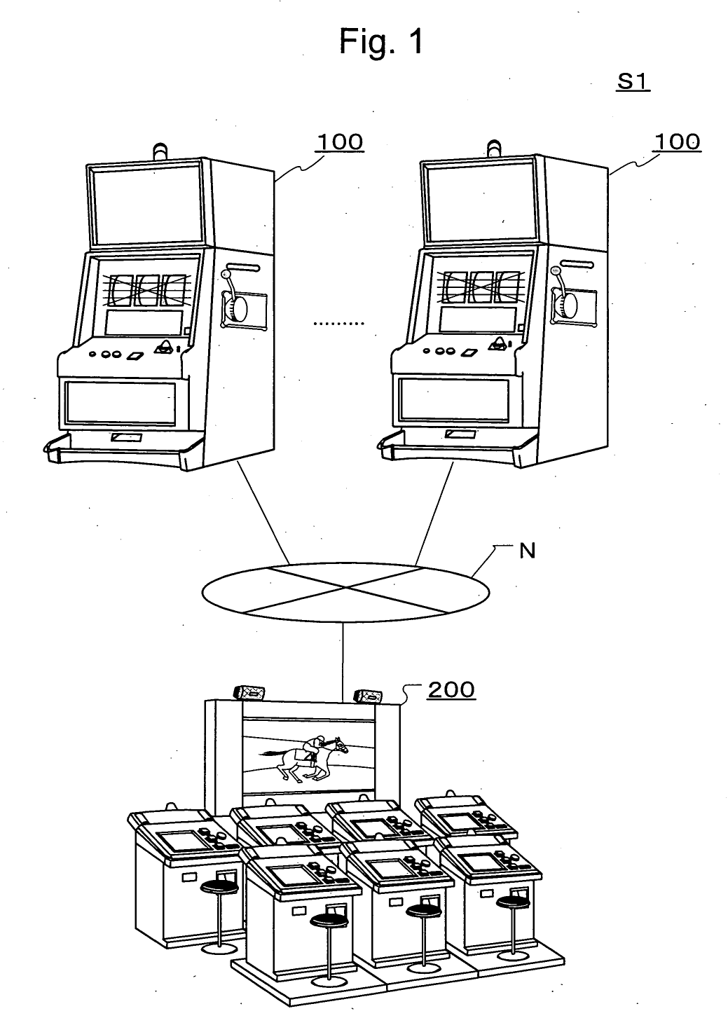

A gaming system S1 shown in FIG. 1 comprises a network N, a plurality of gaming machines 100, and a gaming machine 200.

The network N in the first embodiment is composed of dedicated lines based on a predetermined protocol of the playing system S1.

Here, the network N should not be limited to that of the specific protocol or dedicated lines but may be that composed of the TCP/IP or UDP/IP protocol or the internet of the public communication network.

The gaming machine 100 and the gaming machine 200 in the first embodiment are placed at each gaming place, and the game is played by the player. The gaming machine 100 is a general slot machine, and the gaming machine 200 is the general horse racing game, in which a plurality of players can participate. These gaming machines will be described in connection with their components and functions.

### OUTLINE OF GAMING MACHINE

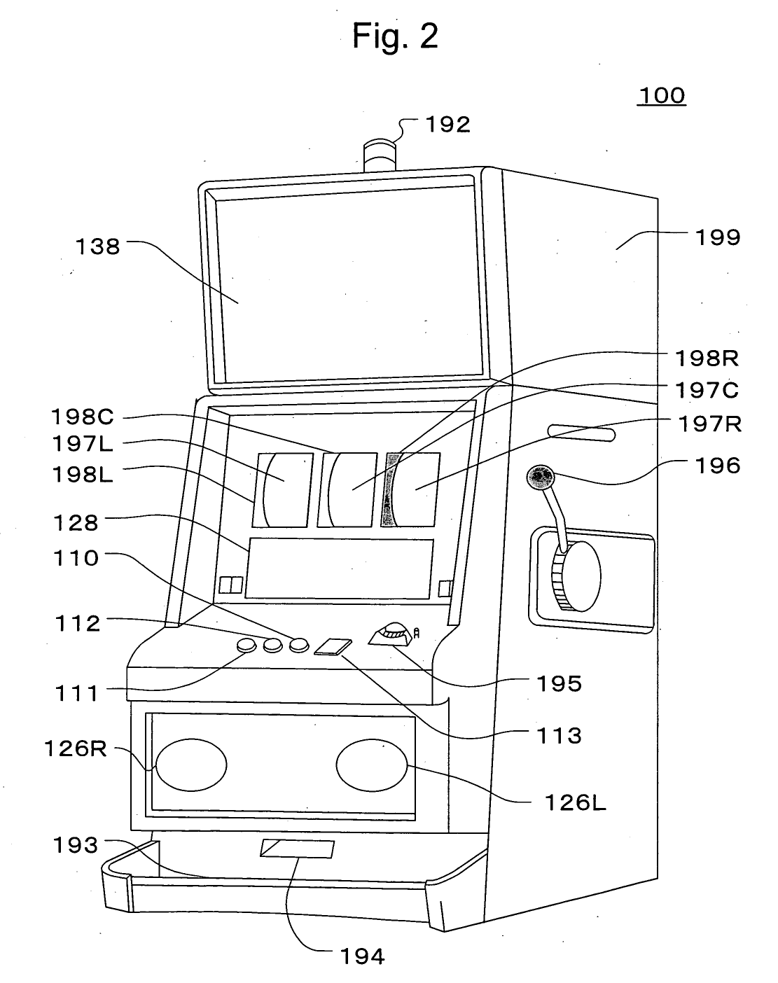

A schematic perspective view of the gaming machine 100 of the first embodiment is shown in FIG. 2.

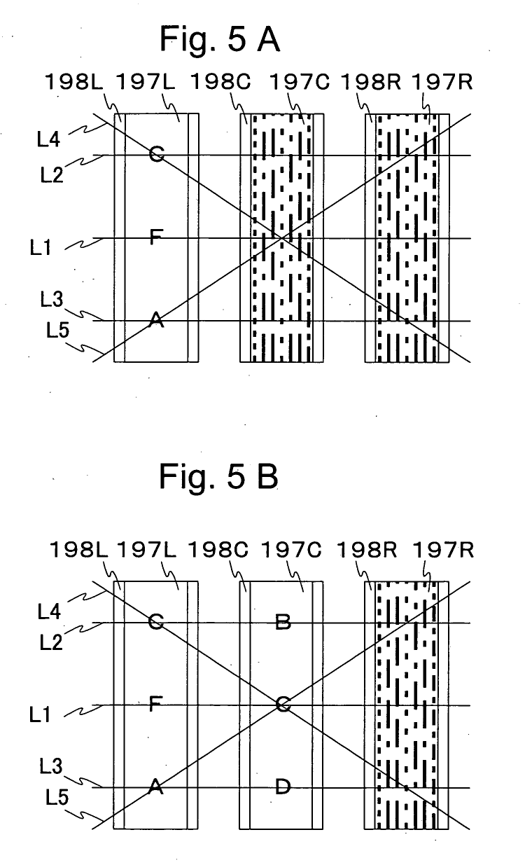

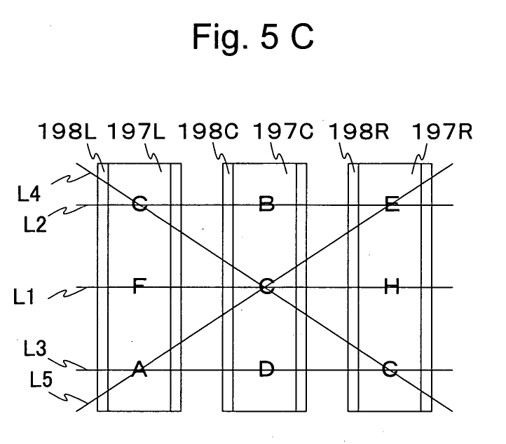

A cabinet 199 forming a main structure of the entire gaming machine 100 is provided on the front face with three rectangular display windows 198 (198L, 198C and 198R) formed vertically elongated. These display windows 198 (198L, 198C and 198R) are provided with five pay lines, i.e., three horizontal lines (i.e., center, upper, and lower lines L1, L2, and L3) and two diagonal lines (i.e., L4 diagnally downward to the right and L5 diagnally upward to the right) (in FIGS. 5A to 5C). These pay lines L1 to L5 are provided, at their left end portions and at their right end portions, with the bet number display portions (not-shown) for displaying the pay lines (as will be called the “activated lines”), which are activated with the number of coins inserted, and the bet number of coins. Those bet number display portions are numbered consecutively downward from “3”, “2”, “1”, “2” and “2”.

When a later-described 1-BET switch 111 is operated by a player, one of the five pay lines such as the pay line L1 is activated, for example. When the 1-BET switch 111 is operated two times, three of the five pay lines such as the pay lines L1 to L3 are activated. When the 1-BET switch 111 is operated three times or when a MAX-BET switch 112 is operated, all the five pay lines L1 to L5 are activated. The pay line or lines activated are explicitly indicated by lighting the activated line indication lamps (not-shown) disposed on the back face of the bet number display.

Three reels 197L, 197C, and 197R are rotatably disposed in the cabinet 199. A plural kinds of symbols are drawn on individual outer circumferential faces of the reels 197L, 197C, and 197R. These reels 197L, 197C, and 197R can be viewed by the player through the aforementioned display windows 198L, 198C, and 198R, respectively. The reels 197L, 197C and 197R are so rotationally driven in the display windows 198L, 198C and 198R that the symbols drawn on the outer circumferential faces of the reels 197L, 197C, and 197R may move downward, as will be detailed hereinafter.

A display device 128 made of a liquid crystal display panel is disposed below the display windows 198L, 198C and 198R. Various effects like graphics on the game are displayed in the display device 128.

The display device 128 may be made of a liquid crystal display panel or a cathode ray tube. In this embodiment, moreover, the display device 128 is disposed at the center of the front face of the gaming machine 100. However, the display device 128 may be disposed at any position of the gaming machine, so long as it can be visually confirmed by the player.

The cabinet 199 is provided on its right side with a tiltable start lever 196. When this start lever 196 is tiled by the player, the rotations of the three reels 197L, 197C and 197R are started all at once. When these three reels 197L, 197C and 197R are rotated, the symbols drawn on the individual outer circumferential faces of the reels 197L, 197C, and 197R are variably displayed in the display windows 198L, 198C, and 198R, respectively.

The cabinet 199 is provided on its front face with a spin switch 110, the 1-BET switch 111, and the MAX-BET switch 112. When these spin switch 110, 1-BET switch 111, and MAX-BET switch 112 are operated by the player, the credit of the coins is reduced, and the pay lines are activated, as will be described hereinafter.

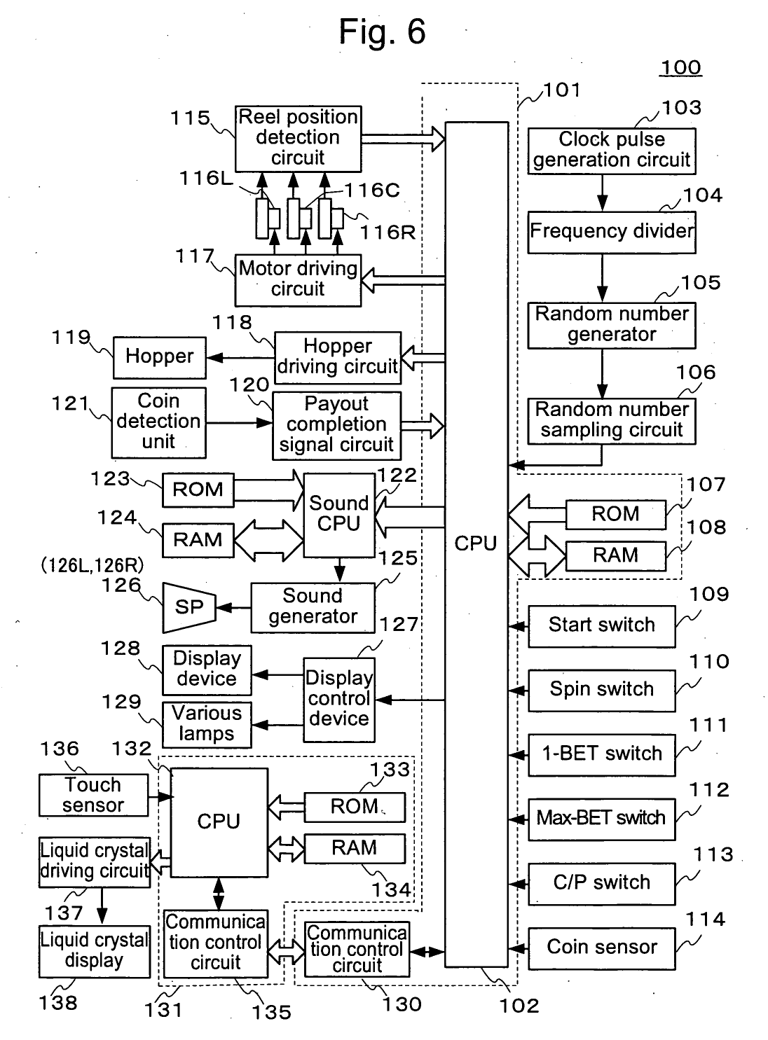

When the spin switch 110 is pressed, the BET number information of the coins at the previous play time is read out from a later-described RAM 108 (FIG. 6), and is input as the BET number of the play at this time to the gaming machine 100.

A C/P (Credit/Pay) switch 113 is disposed on the right side of those spin switch 110, 1-BET switch 111, and Max-BET switch 112.

When the C/P switch 113 is in an “On” position, the C/P switch 113 may be brought in an “Off” position by the player's pressing the switch. Thus, the number of coins in accordance with the credit number are paid out from a coin payout opening 194 into a coin tray 193, as will be described hereinafter.

On the other hand, when the C/P switch 113 is in an “Off” position, the C/P switch 113 may be brought in an “On” position by the player's pressing the switch. Thus, a predetermined number of coins among the coins the player has inserted into the gaming machine 100 are credited.

A coin insertion slot 195 is disposed on the right side of the C/P switch 113.

The cabinet 199 is provided below its front face with the coin payout opening 194 for paying out coins, and the coin tray 193 for receiving the coins paid out. When the coin credit number reaches the upper limit or when the C/P switch 113 is operated, the coins are paid out from the coin payout opening 194.

The cabinet 199 is provided on its front face with speakers 126 (or 126R and 126L). Sounds for playing a game are issued from those speakers 126.

The cabinet 199 is provided at its upper portion with a liquid crystal display 138 as a second display device. This liquid crystal display 138 displays a game screen on the second game (e.g., a horse racing game).

The cabinet 199 is provided thereover with a tower light 192. This tower light 192 is turned on for the game effect.

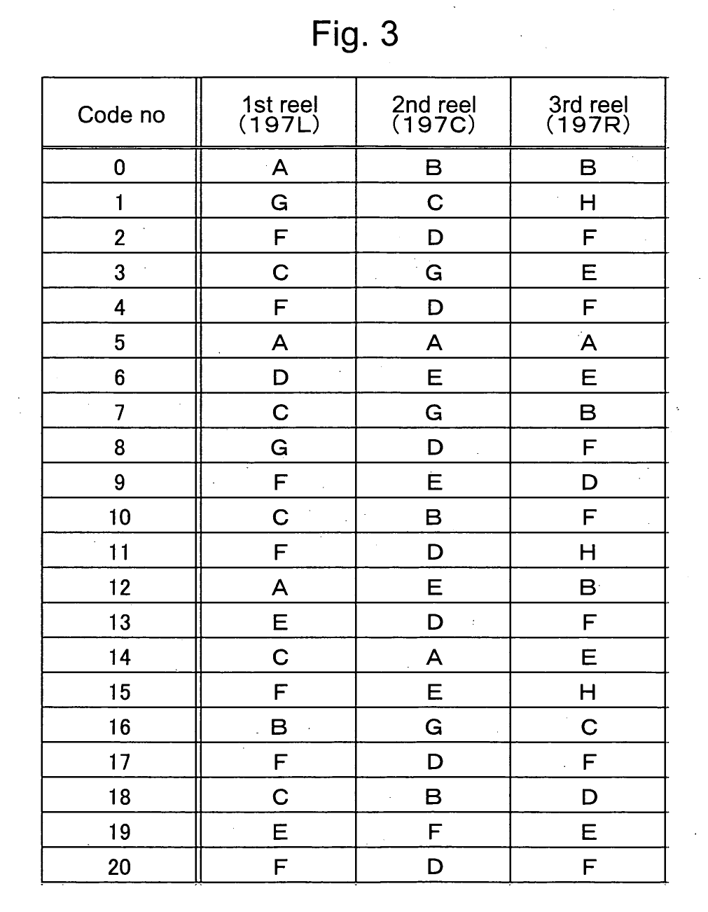

FIG. 3 shows an example table of symbols arranged on the reels 197 (197L, 197C and 197R). In the table shown in FIG. 3, the kinds of symbols are simplified and designated by “A” to “H”. The symbols corresponding to the code numbers are drawn in the order of the code numbers of the table, as shown in FIG. 3, on the individual outer circumferential faces of the reels 197L, 197C, and 197R. When the reel and the code number are determined, it is possible to specify the kind of the symbol. For example, the symbol of the code number “16” in the reel 197R is “C”.

This table is used to make the individual rotational angle positions of the reels 197L, 197C, and 197R, and the various symbols, as will be described hereinafter. When the reels 197L, 197C, and 197R are stopped, for example, the various symbols, which are stopped and displayed on the pay lines L1 to L5 of the display windows 198L, 198C, and 198R, can be specified by referring to the table shown in FIG. 3 on the basis of the information of the individual rotational angle positions of the reels 197L, 197C and 197R.

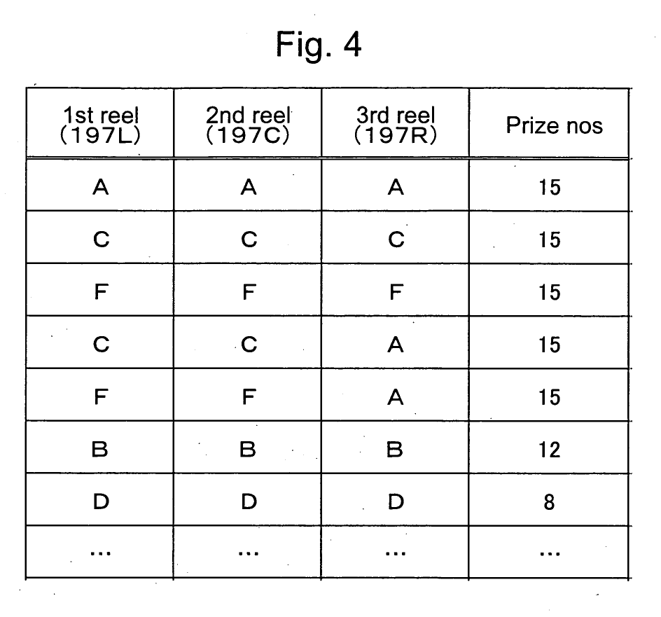

FIG. 4 shows one example of the winning combination table representing the relations between the winning combinations and the respective prize numbers of coins to be paid out as the ordinary prize when such a symbol combination is established. Like FIG. 3, the kinds of symbols are also simplified and designated by “A” to “H”.

When all the three reels 197L, 197C, and 197R are stopped, for example, the prize symbol combination table is referred to. In case the symbol combination stopped on the activated line is “A”-“A”-“A”, for example, a predetermined number of coins, e.g., fifteen coins are paid out. On the other hand, this winning combination table is referred to when all the three reels 197L, 197C, and 197R are stopped.

FIGS. 5A-5C show schematically transition modes, in which a start switch 109 of the gaming machine 100 is turned on by tilting operation of the start lever 196 by the player so that the three reels 197L, 197C, and 197R are rotationally driven and sequentially stopped as the time elapses.

FIGS. 5A, 5B, and 5C show the modes, in which the three reels 197L, 197C, and 197R are stopped in the recited order.

### EKECTRIC CONFIGURATION OF GAMING MACHINE 100

FIG. 6 is a hardware block diagram of the gaming machine 100.

With reference to FIG. 6, the gaming machine 100 is configured to include a main control circuit 101 for controlling the first game (e.g., game of slot machine), and a control circuit 131 for controlling the image display of the second game (e.g., the horse racing game).

In the gaming machine 100, the control is made on the first game (i.e., the slot game) but not on the second game (i.e., the horse racing game). Specifically, the control for executing the second game is made by the gaming machine 200, and what is performed by the control circuit 131 of the gaming machine 100 is to receive pieces of information concerning the image data on the game, the data on the BET and the game result of the gaming machine 200 from the gaming machine 200, and to control and display the information based on the pieces of information.

A first portion enclosed by broken lines in FIG. 6 is the first game of the gaming machine 100, that is, the main control circuit 101 of the “slot” game. This main control circuit 101 includes: a CPU (Central Processing Unit) 102 for performing control operations according to preset programs; a ROM (Read Only Memory) 107 and a RAM (Random Access Memory) 108 acting as storage means; and a communication control circuit 130.

The ROM 107 stores control programs for controlling the flow of the entire game of the gaming machine. Moreover, the ROM 107 stores initial data for executing the control programs, programs for controlling the flashing operation patterns of various lamps 129, and programs for display controls in the display device 128. Further, the ROM 107 stores a probability lottery table to be utilized for determining a random number sampled at each time the start lever 196 (FIG. 2) is operated (for the start operation), a stop control table for determining the stop mode of the reels according to the sampled random number, and various control instructions (or commands) for transmitting signals to various peripheral devices.

Here, the programs in this embodiment are stored in the ROM 107. According to the present invention, however, the programs can cause the CPU 102 to execute various operations so as to realize procedures, means, or functions. The programs may also be stored in recording media, which can be read out by various reading devices connected with the CPU 102, such as a hard disk device, a CD-ROM or a DVD. Moreover, these programs need not be stored in advance but may be stored in the RAM 108 or the like after the power is turned on. Still moreover, individual programs may be stored in individual storage media.

The RAM 108 stores the aforementioned programs and temporarily stores the values of flags and variables to be used in the programs.

The various peripheral devices may be connected with the CPU 102 through a predetermined group of interface circuits (not-shown).

A random number sampling circuit 106 is connected with the CPU 102.

A random number generator 105 is connected with the random number sampling circuit 106, and the random numbers to be generated for a constant period by the random number generator 105 are sampled by the random number sampling circuit 106 so that their information is fed to the CPU 102.

In order that pulses for the constant period may be fed to the random number generator 105 to generate the random numbers for the period in the random number generator 105, a frequency divider 104 is connected with the random number generator 105, and a clock pulse generation circuit 103 is connected with the frequency divider 104. With this configuration, the random numbers are generated in the clock pulse generation circuit 103 with the pulses independent of the main control circuit 101 of the gaming machine 100. The clock pulse generation circuit 103 generates pulses having a frequency independent of the main control circuit 101 of the gaming machine 100, inputs the pulses into the frequency divider 104 and divides the pulses, and generates the random numbers in the random number generator 105 on the basis of the frequency-divided pulses.

In this embodiment, the gaming machine 100 is configured to include the random number generator 105, and the random numbers generated from the random number generator 105 are stored in the RAM 108 by the CPU 102. However, the present invention should not be limited to that storage, but the CPU 102 may generate the random numbers on the basis of the programs stored in the ROM 107.

A motor driving circuit 117 is connected with the CPU 102. Stepping motors 116L, 116C, and 116R for driving the aforementioned three reels 197L, 197C, and 197R to rotate, respectively, are connected with the motor driving circuit 117. The stepping motors 116L, 116C, and 116R are so disposed in the three reels 197L, 197C, and 197R, respectively, that their rotary shafts may be positioned at the rotation centers of the reels 197L, 197C, and 197R.

A drive control instruction to be transmitted from the CPU 102 is converted into a drive signal by the motor driving circuit 117, and the drive signal is fed to the stepping motors 116L, 116C, and 116R. Here, the drive control instruction contains an instruction of the rotation speed to control the rotations and stops of the stepping motors 116L, 116C, and 116R, and to control the rotation speeds.

The CPU 102 controls the stepping motors 116L, 116C, and 116R as described above so that it can control the rotation-and-stops and the rotation speeds of the reels 197L, 197C, and 197R.

The reels 197L, 197C, and 197R are individually provided with the rotation angle position sensors (not-shown) for detecting the rotation angle positions of the individual reels. These rotation angle position sensors are connected with a reel position detection circuit 115. The signals indicating the individual rotation angle positions of the reels 197L, 197C, and 197R are fed to the reel position detection circuit 115 when the indication signals are transmitted from the rotation angle position sensors. The indication signals are converted into predetermined kinds of signals and then fed to the CPU 102.

The CPU 102 calculates the code numbers of the symbols from the fed rotation angle positions and refers to the table shown in FIG. 3 so that it can specify the symbols to be individually displayed in the display windows 198L, 198C, and 198R.

A coin sensor 114 is disposed in the vicinity of the coin insertion slot 195 (FIG. 2) and connected with the CPU 102. This coin sensor 114 feeds the CPU 102 with an inserted-coin calculation signal for detecting that the coins are inserted into the coin insertion slot 195.

Moreover, the spin switch 110, the 1-BET switch 111, and the MAX-BET switch 112 are connected with the CPU 102. The BET signals are fed to the CPU 102 when the spin switch 110, the 1-BET switch 111, and the MAX-BET switch 112 are operated by the player.

Here, to “BET” means to “bet coins” in the game.

Moreover, the C/P switch 113 is connected with the CPU 102. The C/P switch 113 feeds the C/P signal to the CPU 102 on the basis of the operation of the player.

Moreover, the start switch 109 disposed near the start lever 196 is connected with the CPU 102. The start switch 109 feeds the start signal to the CPU 102 on the basis of the operation of the start lever 196.

Moreover, a sound CPU 122 is connected with the CPU 102. The sound CPU 122 makes the speakers 126 (126L and 126R) emit sounds when it receives a sound generation instruction signal fed from the CPU 102.

A ROM 123, a RAM 124 and a sound generator 125 are connected with the sound CPU 122. Moreover, the speakers 126 (126L and 126R) are connected with the sound generator 125.

The ROM 123 is stored with sound data. When the sound CPU 122 receives the aforementioned sound generation instruction signal, it reads out the sound data based on that signal, from the ROM 123. Here, the sound CPU 122 stores the RAM 124 temporarily with the data fed from the CPU 102 and the sound data read from the ROM 123. Moreover, the sound CPU 122 feeds the read sound data to the sound generator 125, which generates sounds by converting the sound data into predetermined signals and by feeding these signals to the speakers 126.

Moreover, a display control device 127 is connected with the CPU 102. When the display control device 127 receives an image display instruction signal from the CPU 102, it controls the display device 128 and the various lamps 129, which are connected therewith. Here, these various lamps 129 contain the tower light 192 (FIG. 2).

Moreover, a hopper driving circuit 118 is connected with the CPU 102, and a hopper 119 is connected with the hopper driving circuit 118. In the stop mode indicating the winning mode of an internal winning combination, as shown in FIG. 4, the CPU 102 feeds a payout instruction signal to the hopper driving circuit 118 so that a predetermined number of coins are paid out from the hopper 119. At this time, a coin detection unit 121 counts the number of coins to be paid out from the hopper 119, and feeds a coin payout completion signal to a payout completion signal circuit 120 when the counted value reaches a designated number. Then, the payout completion signal circuit 120 feeds that coin payout completion signal to the CPU 102. Here, the gaming machine 100 of this embodiment can credit five hundreds coins and pays out the coins unconditionally when the coin number exceeds five hundreds. Moreover, the coins are also paid out when the C/P switch 113 feeds the C/P signal to the CPU 102 as described above. As a result, the CPU 102 stops driving the hopper 119 through the hopper driving circuit 118 and terminates the coin payout process.

Moreover, the communication control circuit 130 is connected with the CPU 102. This communication control circuit 130 communicates with a communication control circuit 135 constituting the control circuit 131 of the later-described second game (i.e., the horse racing game), and transmits/receives pieces of information on the insertion/payout of the game media in the second game to-and-from the second game control circuit 131.

A second portion enclosed by the broken lines in FIG. 6 is the control circuit 131 of the second game, i.e., the “horse racing game” of the gaming machine 100. The control circuit 131 includes: a CPU 132 for performing the control according to the control information transmitted from the gaming machine 200; a ROM 133 and a RAM 134 as storage means; and the communication control circuit 135.

The ROM 133 is stored with control programs and various control instructions (or commands) for controlling connection devices connected with the control circuit 131 of the gaming machine 100, that is, a touch sensor 136, a liquid crystal driving circuit 137, and the liquid crystal display 138. Moreover, the ROM 133 is stored with initial data for executing the control programs.

The RAM is stored at the execution time with the body of the aforementioned control programs and temporarily with the values of variables to be used in the control programs.

The various peripheral devices are connected with the CPU 132 through a predetermined group of interface circuits (not-shown).

The touch sensor 136 is connected with the CPU 132. When the later-described liquid crystal display showing the operation display is operated by the player, the touch sensor 136 detects the operation and feeds the detection signal to the CPU 132.

Here in this embodiment, the touch sensor 136 constitutes a portion of the “game operation means for operating the game operation means of the second game”. However, the invention should not be limited to, but the “game operation means for operating the game operation means of the second game” may also be configured for detecting the operation of the player with a switch and for feeding the detection signal to the CPU 132.

Moreover, the liquid crystal driving circuit 137 is connected with the CPU 132. When the signal of the information on the display image is fed from the CPU 132 to the liquid crystal driving circuit 137, the signal of the display image is fed to the later-described liquid crystal display 138 on the basis of that signal.

The liquid crystal display 138 is connected with the liquid crystal driving circuit 137. The liquid crystal display 138 receives the signal of the display image fed from the liquid crystal driving circuit 137, and displays that image.

Here in this embodiment, the liquid crystal driving circuit 137 and the liquid crystal display 138 constitute the display device of the second game. However, the invention should not be limited thereto, but the display device may also be composed of a CRT (Cathode Ray Tube) display, an EL (Electronic Luminescence) display, or a plasma display, for example.

### OUTLINE OF GAMING MACHINE 200

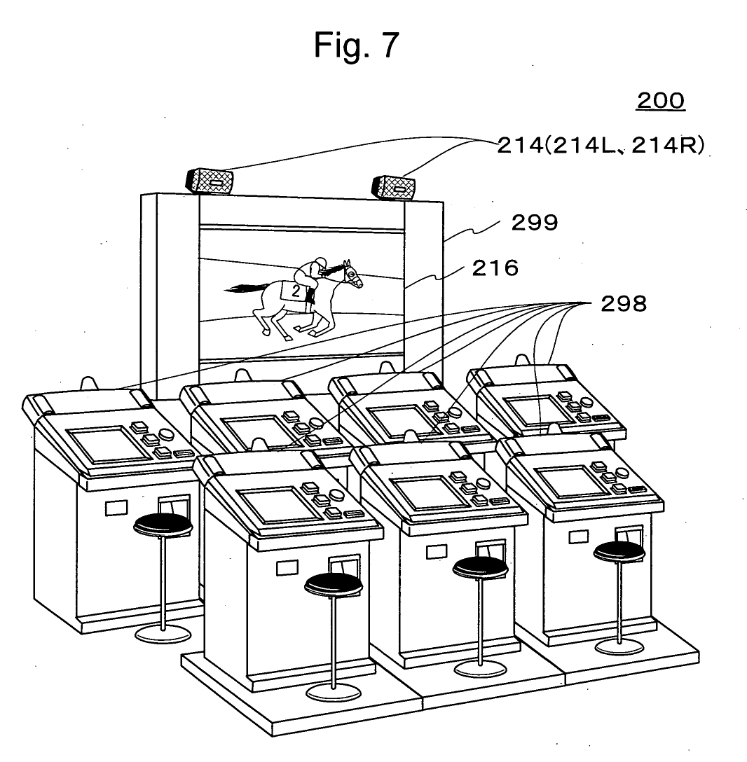

The schematic perspective view of the gaming machine 200 of this embodiment is shown in FIG. 7.

The gaming machine 200 is a gaming machine for performing the horse racing game. This gaming machine 200 is generally configured to include: a cabinet 299 provided with a device for processing the game and a display device for displaying an image of the game; and a plurality of control terminals disposed before the cabinet 299 and connected communicatively with the device for processing the game in the cabinet 299. The plurality of control terminals provide a plurality of players with operable operation portions.

The cabinet 299 constituting the main body of the gaming machine 200 is provided with a substantially rectangular display device 216 on the front face. The invention should not be limited thereto, but may be provided with a CRT display, an EL display, a plasma display, or the like.

This display device 216 displays images on the horse racing game, such as pari-mutuel winning percentages (i.e., the so-called “odds”), horse race situations, or the results of horse races, so that a plurality of players playing the game at the control terminals 298 may visually confirm the game images of the horse racing game.

The cabinet 299 constituting the main body of the gaming machine 200 is provided thereover with two speakers 214 (214L and 214R). These speakers emit sounds for the effects of the game to the players who participate in the game by operating the control terminals 298.

Here, the image displayed on the display device 216 is transmitted as image data through the network N (FIG. 1) from the gaming machine 200 to the gaming machines 100. This display image is identical to that, which is displayed on the liquid crystal display 138 (FIG. 6) on the side of the gaming machine 100 when the communication control circuit 135 of the control circuit 131 (FIG. 6) receives those image data.

In this embodiment, the gaming machine 200 has the display device 216 comprising a liquid crystal display and displays the images of the situations or results of the horse race, which are combined with the image data stored in a ROM 203. The invention should not be limited thereto, but may have an additional configuration, in which model horses (not real horses) are raced on a model racecourse. In this case, the images of the horse race situations to be displayed on the display device 216 of the gaming machine 200 and on the liquid crystal display 138 of the gaming machine 100 are displayed by means for displaying the images which are combined with the image data stored in advance in the ROM 203. Alternatively, the means for displaying the images may display the images which are taken from the model horse race in the model racecourse by a CCD camera or the like.

### ELECTRIC CONFIGURATION OF GAMING MACHINE 200

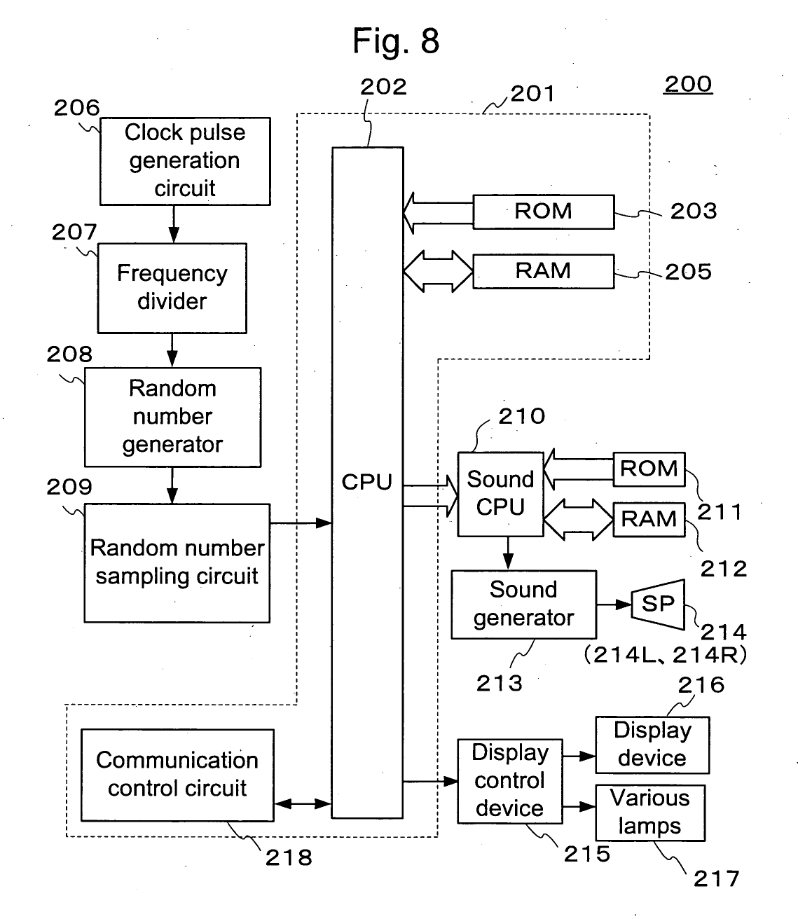

FIG. 8 is a hardware block diagram of the gaming machine 200.

A portion enclosed by broken lines in FIG. 8 is a main control circuit 201 of the gaming machine 200. The main control circuit 201 constituting second game control means includes: a CPU 202 for performing control operations according to preset programs; the ROM 203 and a RAM 205 acting as storage means; and a communication control circuit 218.

The ROM 203 stores control programs for controlling the flow of the entire game of the gaming machine 200, and image data on the game. Moreover, the ROM 203 stores initial data for executing the control programs, and programs for controlling the displays in the display device 216. Still moreover, the ROM 203 stores various control instructions (or commands) for transmitting signals to the various peripheral devices.

Here, the programs in this embodiment are stored in the ROM 203. In the invention, however, the programs can cause the CPU 202 to execute the various operations so as to realize procedures, means, or functions. The programs may also be stored in recording media, which can be read out by various reading devices connected with the CPU 202, such as a hard disk device, a CD-ROM, or a DVD. Moreover, these programs need not be stored in advance but may be stored in the RAM 205 or the like after the power is turned on. Still moreover, the individual programs may be stored in different storage media.

The RAM 205 stores the values of flags and variables to be used in the aforementioned programs.

The various peripheral devices are connected with the CPU 202 through a predetermined group of interface circuits (not-shown).

A random number sampling circuit 209 is connected with the CPU 202.

A random number generator 208 is connected with the random number-sampling circuit 209, and the random numbers to be generated for a constant period by the random number generator 208 are sampled by the random number sampling circuit 209 so that their information is fed to the CPU 102.

In order that pulses for the constant period may be fed to the random number generator 208 to generate the random numbers for the period in the random number generator 208, a frequency divider 207 is connected with the random number generator 208, and a clock pulse generation circuit 206 is connected with the frequency divider 207. With this configuration, the random numbers are generated in the clock pulse generation circuit 206 with the pulses independent of the main control circuit 201 of the gaming machine 200. The clock pulse generation circuit 206 generates pulses having a frequency independent of the main control circuit 201 of the gaming machine 200, inputs the pulses into the frequency divider 207 and divides the pulses, and generates the random numbers in the random number generator 208 on the basis of the frequency-divided pulses.

In this embodiment, the gaming machine 200 is configured to include the random number generator 208, and the random numbers generated by the random number generator 208 are stored in the RAM 205 by the CPU 202. However, this invention should not be limited to that storage, but the CPU 202 may generate the random numbers on the basis of the programs stored in the ROM 203.

Moreover, a sound CPU 210 is connected with the CPU 202. The sound CPU 210 generates sounds from the speakers 214 when it receives a sound generation instruction signal fed from the CPU 202.

A ROM 211, a RAM 212 and a sound generator 213 are connected with the sound CPU 210. Moreover, the speakers 214 (214L and 214R) are connected with the sound generator 213.

The ROM 211 is stored with sound data. When the sound CPU 210 receives the aforementioned sound generation instruction signal, it reads out the sound data based on that signal, from the ROM 211. Here, the sound CPU 210 makes the RAM 212 store temporarily the data fed from the CPU 202 and the sound data read from the ROM 211. Moreover, the sound CPU 210 feeds the read sound data to the sound generator 213, which generates sounds by converting the sound data into predetermined signals and by feeding these signals to the speakers 214.

Moreover, a display control device 215 is connected with the CPU 202. When the display control device 215 receives an image display instruction signal from the CPU 202, it controls the display device 216 and various lamps 217 connected therewith. These various lamps 217 are the general name of a lamp group attached to the cabinet 299 of the gaming machine 200 for performing various effects on the game (i.e., the horse racing game).

Moreover, the communication control circuit 218 is connected with the CPU 202. This communication control circuit 218 communicates with the communication control circuit 135 constituting the control circuit 131 of the second game (i.e., the horse racing game) of the gaming machine 100, and transmits/receives various pieces of information (e.g., the game image information, the BET information, the game lottery result information and the winning percentage determination information) of the second game (i.e., the horse racing game) to-and-from the second game control circuit 131.

Moreover, the communication control circuit 218 communicates with the communication control circuit (not-shown) constituting the control circuit (not-shown) of the control terminals 298, and transmits/receives the various pieces of information (e.g., the game image information, the BET information, the game lottery result information, and the winning percentage determination information) of the horse racing game.

### OPERATIONS OF GAMING MACHINE

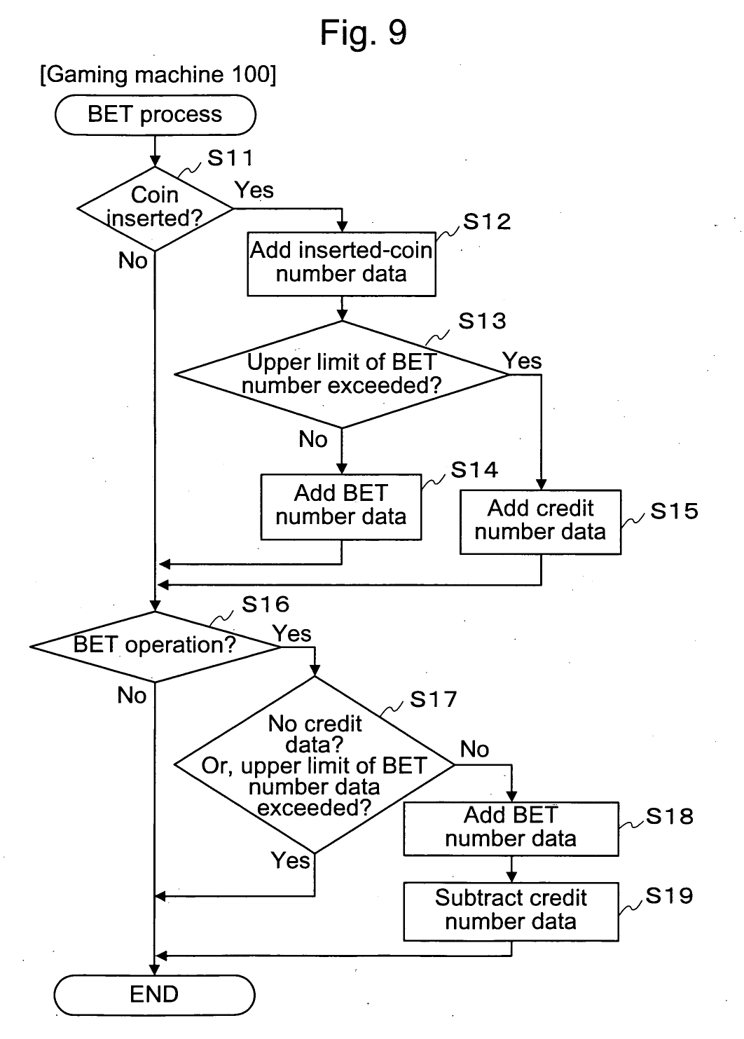

First of all, the subroutine for controlling the BET process to be executed in the main control circuit of the gaming machine 100 is shown in FIG. 9.

Here, this subroutine is called with the gaming machine 100 when the player performs BET (or bets coins) in the first game (i.e., the slot game) and in the second game (i.e., the horse racing game).

Thus, the first game (i.e., the slot game) and the second game (i.e., the horse racing game) share the BET-process. This is because information of the number of payout coins with the hopper and deposit coins with the coin deposition is shared for the payout and BET of the coins in the gaming machine 100. Specifically, the coins inserted into the gaming machine 100 or credited by the player can be bet in either the first game or the second game. No matter whether the prize is given to pay out the coins in the first game or in the second game, the hopper is commonly used to give the prize and pay out the coins.

With reference to FIG. 9, it is determined at Step S11 whether or not a coin has been inserted. In this operation, the coin sensor 114 (FIG. 6) of the gaming machine 100 feeds, when it detects the insertion of the coin by the player, a detection signal to the CPU 102. The subroutine proceeds to Step S12, in case the coin sensor 114 detects the coin insertion, and to Step S16 in case the coin sensor 114 does not detect the coin insertion.

At Step S12, the data of the numbers of inserted coins are added. In this operation, the CPU 102 of the gaming machine 100 increments (or adds 1) the variables arranged in the RAM 108 for storing the data of the numbers of the inserted coins. After this operation ends, the subroutine proceeds to Step S13.

Next at Step S13, with reference to the inserted-coin number data stored at Step S12, it is determined whether or not the upper limit of the BET number has been exceeded. In this operation, the CPU 102 of the gaming machine 100 reads out the BET number upper limit stored in the ROM 107 to the RAM 108, and compares with the read upper limit with the inserted-coin number data stored in the RAM 108. In case it is determined that the inserted-coin number data have exceeded the BET number upper limit, the subroutine proceeds to Step S15. In case it is determined that the inserted-coin number data have not exceeded the BET number upper limit, on the other hand, the subroutine proceeds to Step S14.

Next at Step S14, the BET number data are added. In this operation, the CPU 102 of the gaming machine 100 increments the variables arranged in the RAM 108 for storing the data of the BET numbers. After this operation ends, the subroutine proceeds to Step S16.

At Step S15, on the other hand, the CREDIT number data are added. In this operation, the inserted coins, the number of which has been determined at Step S13 to exceed the BET number upper limit, are added to the CREDIT number. The CPU 102 of the gaming machine 100 increments the variables arranged in the RAM 108 for storing the CREDIT number data. After this operation ends, the subroutine proceeds to Step S16.

Next at Step S16, it is determined whether or not the BET operation has been performed. In this operation, any of the spin switch 110 (FIG. 6), the 1-BET switch 111, and the MAX-BET switch 112 of the gaming machine 100 is operated by the player so that the operation signal is fed to the CPU 102. In this case, the subroutine proceeds to Step S17. In case the operation signal is not fed, on the other hand, this subroutine is instantly ended.

Next at Step S17, it is determined whether the CREDIT number is “0”, or the upper limit of the BET number data is exceeded. In this operation, the CPU 102 of the gaming machine 100 refers to the variables arranged for storing the CREDIT number data and the variables for storing the BET number data in the RAM 108. In case it is determined that the CREDIT number is “0” or that the BET number data have exceeded the upper limit, this subroutine is instantly ended. Otherwise, the subroutine proceeds to Step S18.

Next at Step S18, the BET number data are added. In this operation, the CPU 102 of the gaming machine 100 increments the variables arranged in the RAM 108 for storing the BET number data. After this operation ends, the operation proceeds to Step S19.

Next at Step S19, the CREDIT number data are subtracted. In this operation, the CPU 102 of the gaming machine 100 decrements (or subtract 1) the variables arranged in the RAM 108 for storing the CREDIT number data. After this operation ends, this subroutine ends.

### SLOT GAME PROCESS

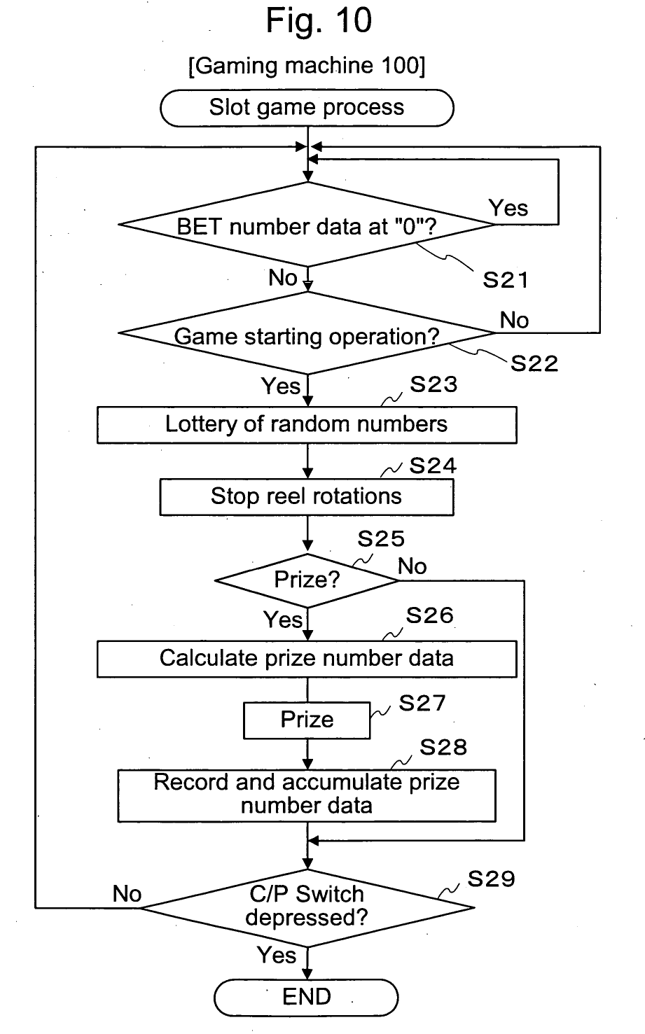

Next, a subroutine for controlling the slot game process to be executed in the main control circuit of the gaming machine 100 is shown in FIG. 10.

With reference to FIG. 10, at Step S21, it is determined whether or not the BET number data are at “0”. In this operation, the CPU 102 of the gaming machine 100 reads out the BET number data stored in the RAM 108. The routine returns again to Step S21 in case it is determined that the BET number data are at “0”. But the operation proceeds to Step S22 in case it is determined that the BET number data are not at “0”.

Next at Step S22, it is determined whether or not the game starting operation has been performed. In this operation, the CPU 102 of the gaming machine 100 determines whether or not it has received the start signal fed from the start switch 109. As a result, the CPU 102 proceeds to Step S23 in case it determines that it has received the start signal, but returns to Step S21 in case it determines that it has not received the start signal. As a result, the game is not started till the start lever 196 (FIG. 2) is operated.

Next at Step S23, a lottery of random numbers is executed. In this operation, the rotation speeds and stop symbols in the reel rotation stopping operation of the later-described Step S24 are determined with the random numbers to be drawn. In this embodiment, the random number generator 105 of the gaming machine 100 generates random numbers within a range of 0 to 16383 (=2¹⁴) patterns, and the random number sampling circuit 106 samples one random number and feeds the sampled random number to the CPU 102. This CPU 102 stores the random number and the internal lottery data based on that random number, in the variables arranged in the RAM 108. In case this operation ends, the subroutine proceeds to Step S24.

Next at Step S24, the reel rotation stopping operation is executed. In this operation, the CPU 102 of the gaming machine 100 transmits a drive control instruction to the motor driving circuit 117 (FIG. 6). In this operation, moreover, the rotation speed, the stop symbols and so on are determined on the basis of the internal lottery data stored in the RAM 108 by the operation of Step S23. When the reels 197L, 197C, and 197R (FIG. 2) are stopped, the subroutine proceeds to Step S25.

Here, the CPU 102 of the gaming machine 100 stops the reels 197L, 197C, and 197R on the basis of the internal lottery data recorded in the RAM 108 by the operation of Step S23, so that the predetermined symbols may be displayed in the display windows 198L, 198C, and 198R.

Next at Step S25, it is determined whether or not a prize has been got. In this operation, the subroutine proceeds to Step S26, in case the CPU 102 of the gaming machine 100 determines that the symbols of the reels 197L, 197C, and 197R stopped and displayed on the activated lines are in the stopping mode indicating the establishment of the prize won internally, as shown in FIG. 4. In case it is determined that the symbols of the reels 197L, 197C, and 197R stopped and displayed on the activated lines are not in the stopping modes indicating the establishment of the prize won internally, on the other hand, the subroutine proceeds to Step S29.

Next at Step S26, the calculation of the prize number data is executed. In this operation, the CPU 102 of the gaming machine 100 detects the symbols of the reels 197L, 197C, and 197R stopped and displayed on the activated lines. As shown in FIG. 4, the CPU 102 calculates the prize number data and records the data in the RAM 108. In case this operation ends, the subroutine proceeds to Step S27.

Next at Step S27, the prize operation is executed. In this operation, the CPU 102 of the gaming machine 100 increases and updates the credit number data on the basis of the prize number data recorded in the RAM 108 by the operation of Step S26. Alternatively, the CPU 102 pays out a predetermined number of coins by feeding the payout instruction signal to the hopper driving circuit 118 (FIG. 6). At this time, the coin detection unit 121 (FIG. 6) counts the number of coins to be paid out from the hopper 119, and feeds the coin payout completion signal to the CPU 102 when the counted value reaches a designated number. In case this operation ends, the subroutine proceeds to Step S28.

Next at Step S28, the accumulative recording operation of the prize accumulated data is executed. In this operation, the CPU 102 of the gaming machine 100 reads out the prize number data recorded in the RAM 108 by the operation of Step S26, and adds the read data to the variables arranged in the RAM 108 for storing the prize accumulated data. In case this operation ends, the subroutine proceeds to Step S29.

Next at Step S29, it is determined whether or not the C/P switch 113 (FIG. 6) has been pressed. In this operation, the credited coins are paid out in case the C/P switch of the gaming machine 100 is operated so that the operation signal is fed to the CPU 102 of the gaming machine 100, and this subroutine is ended. In case-the operation signal is not fed to the CPU 102, on the other hand, the subroutine returns to the operation of Step S21.

### TRANSMISSION/RECEPTION OF GAME DATA AND IMAGE DATA ON SECOND GAME

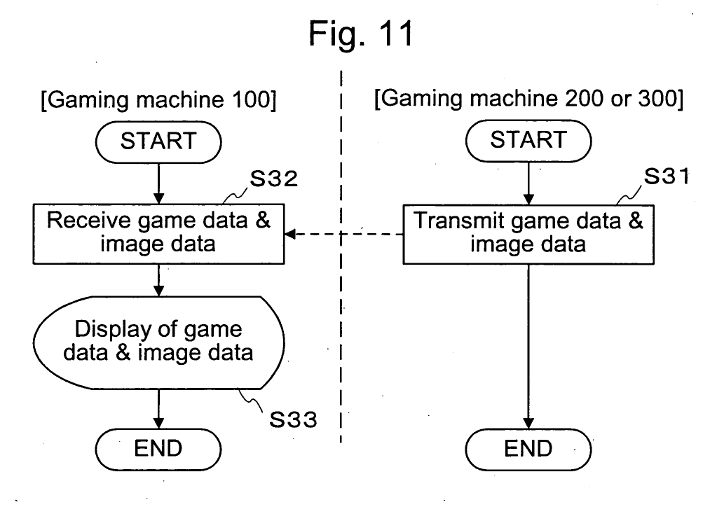

Next, a subroutine, in which communications are made between the gaming machine 100 and the gaming machine 200 to control the transmission/reception of the game data and the image data on the second game, is shown in FIG. 11.

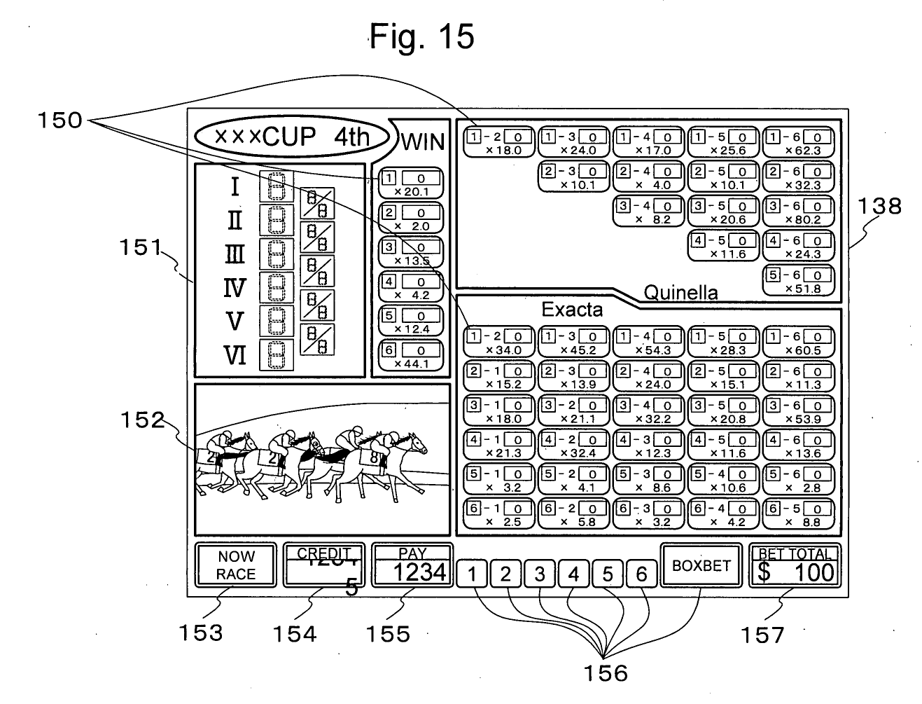

One example of the game data and the image data to be transmitted/received in this subroutine is shown in FIG. 15.

Here, this process is a subroutine to be executed at an interval of a constant time period, while the BET operation of the second game (i.e., the horse racing game) can be performed in the gaming machine 100, by the timer controlled by the CPU 202 of the gaming machine 200, as will be described hereinafter.

Moreover, this subroutine is independent of the BET process shown in FIG. 9 and the slot game process shown in FIG. 10.

With reference to FIG. 11, at Step S31, the gaming machine 200 transmits the game data and the image data to the gaming machine 100. This subroutine is started to execute operation of this step when the CPU 202 of the gaming machine 200 determines that a predetermined time period has elapsed after the timer is counted up. In this operation, the CPU 202 of the gaming machine 200 transmits both the latest data on the game such as the BET situations and the image data for displaying the latest game situations in the signal form to the gaming machine 100 through the communication control circuit 218. When this operation ends, the process on the side of the gaming machine 200 ends. Then, the counter of the timer is cleared, and the count-up of the timer is started again.

At Step S32, on the other hand, the signals transmitted at Step S31 from the gaming machine 200 are received on the side of the gaming machine 100. In this operation, the subroutine proceeds to Step S33, in case the CPU 132 in the second game control circuit of the gaming machine 100 detects the reception of the aforementioned signal.

Next at Step S33, the data on the game and the image data are displayed on the basis of the signal received at Step S32. In this operation, the CPU 132 of the second game control circuit of the gaming machine 100 feeds the received signal to the liquid crystal driving circuit 137. This liquid crystal driving circuit 137 transforms that received into the signal which can be displayed in the liquid crystal display 138, and feed the transformed signal to the liquid crystal display 138, so that an image based on the fed signal is displayed in the liquid crystal display 138. When this operation ends, this subroutine ends.

### TRANSMISSION/RECEPTION OF BET DATA ON SECOND GAME

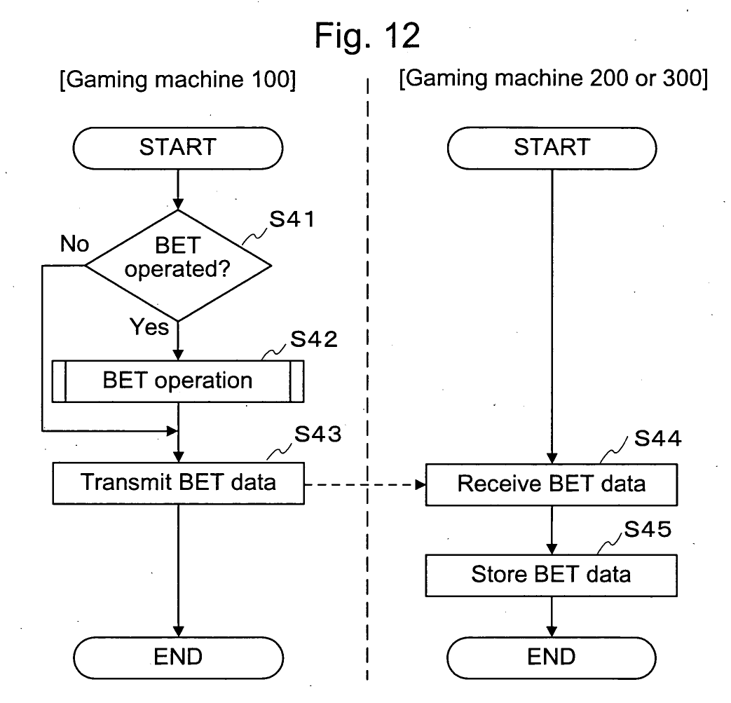

Next, a subroutine, in which communications are made between the gaming machine 100 and the gaming machine 200 to control the transmission/reception of the BET data on the second game, is shown in FIG. 12.

In this subroutine, the BET process is performed by the player in the second game of the gaming machine 100.

This subroutine is independent of the slot game process shown in FIG. 10 and the transmission/reception process of the game data and the image data shown in FIG. 11. The subroutine can be executed so long as the BET operation by the player is accepted by the gaming machine 100 and the gaming machine 200.

With reference to FIG. 12, at Step S41, the gaming machine 100 transmits the BET number data to the gaming machine 200. In this operation, the player performs the BET operation on the display screen, as shown in FIG. 15, in the liquid crystal display 138 of the gaming machine 100. For example, both operation displays 150 and 156 of FIG. 15 are operation displays for the player to input the BET numbers. When the player touches those operation displays so as to input the BET number, the touch is detected by the sensor 136 so that the detection signal is fed to the CPU 132 of the second game control circuit 131 of the gaming machine 100. In case the CPU 132 of the gaming machine 100 is fed with the detection signal, the subroutine proceeds to Step S42. In case the detection signal is not fed, this subroutine is instantly ended.

Here, the BET number inputting operation by the player is that in the premise that the coins are inserted into the gaming machine 100 or that the CREDIT is not at “0”.

Next at Step S42, the BET operation is performed. In this operation, the CPU 102 of the gaming machine 100 calls and executes a subroutine similar to the BET operation shown in FIG. 9. When this operation ends, the subroutine proceeds to Step S43.

Next at Step S43, the BET data input by the player at Step S42 are transmitted to the gaming machine 200. In this operation, the BET number input to bet by the player at Step S42 is transmitted by the CPU 132 of the gaming machine 100 through the communication control circuit 135 to the gaming machine 200. When this operation ends, the process of the gaming machine 100 in this subroutine ends.

On the side of the gaming machine 200, on the other hand, at Step S44, the BET data transmitted from the gaming machine 100 are received. In this operation, the communication control circuit 218 of the gaming machine 200 detects the reception of the signal on the BET data transmitted from the gaming machine 100, and feeds the received signal to the CPU 202. When this operation ends, the subroutine proceeds to Step S45.

Next at Step S45, the CPU 202 of the gaming machine 200 stores the BET data received in Step S44 in the variables arranged in the RAM 205 for storing the BET data. When this operation ends, this subroutine ends.

### TRANSMISSION/RECEPTION OF DATA ON EXECUTIONS OF SECOND GAME

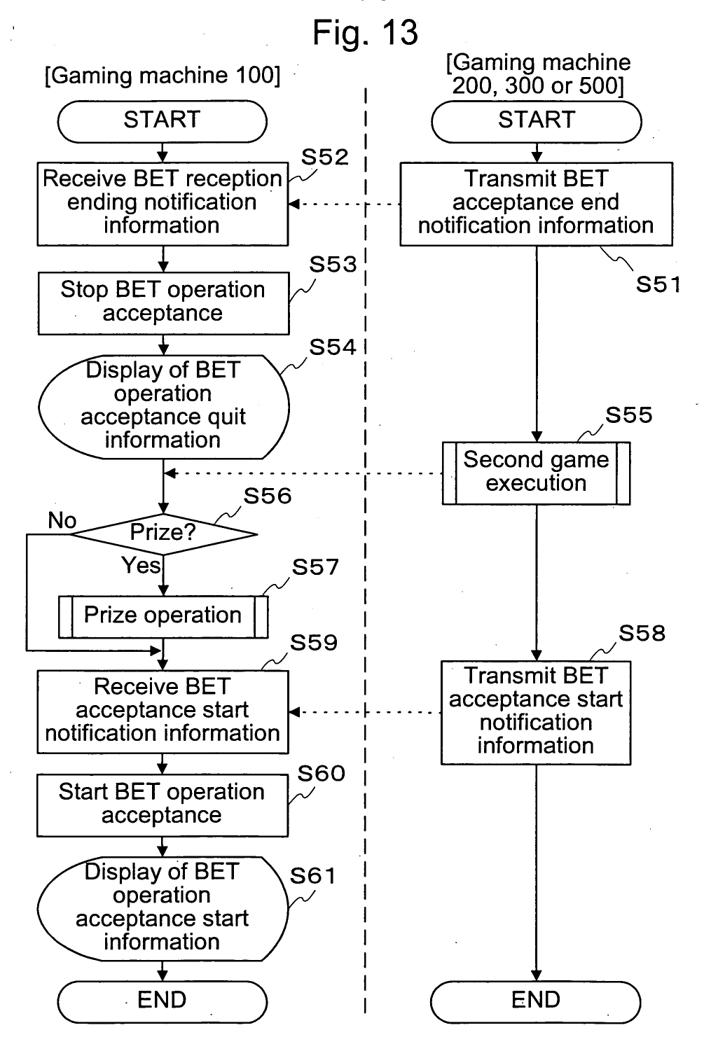

Next, a subroutine, in which communications are made between the gaming machine 100 and the gaming machine 200 to control the transmission/reception of the data on the second game executions, is shown in FIG. 13.

First of all, on the side of the gaming machine 200, at Step S51, the BET acceptance end notification information is transmitted. In this operation, the CPU 202 of the gaming machine 200 transmits the signal, which inhibits the acceptance of the BET operation from the gaming machine 100 at the time of execution of the second game to be controlled by the gaming machine 200, to the gaming machine 100 through the communication control circuit 218. When this operation ends, the gaming machine 200 advances the subroutine to Step S55.

At Step S52, on the other hand, the BET acceptance end notification information transmitted from the gaming machine 200 is received. In this operation, the communication control circuit 135 of the gaming machine 100 detects the reception of that signal and feeds the detected signal to the CPU 132. After this operation ends, the gaming machine 100 advances the subroutine to Step S53.

At Step S53, the acceptance of all the operations in the operation display in the liquid crystal display 138 of the gaming machine 100 is stopped on the basis of the reception of the signal of the BET acceptance end notification information at Step S52. In this operation, the CPU 132 of the gaming machine 100 feeds the liquid crystal drive signal 137 with the signal to stop the operation acceptance of the operation display of the liquid crystal display 138. On the basis of this signal, the liquid crystal driving circuit 137 feeds image signals to the liquid crystal display 138 so that the liquid crystal display 138 may be disabled to accept the operation of the operation display. When this operation ends, the subroutine proceeds to Step S54.

Next at Step S54, the BET operation acceptance stop information is displayed. In this operation, it is displayed in the liquid crystal display 138 of the gaming machine 100 that the BET operation acceptance has been stopped at Step S53. When “NOW BET” is displayed at a display 153 in FIG. 15, for example, it is possible to input the BET number from that screen. When “NOW RACE” is displayed by the operation of Step S54, however, it means that “the race is being held”, and it is possible to indicate that the BET number cannot be input to the operation displays 150 and 156 of the liquid crystal display 138. When this operation ends, the subroutine proceeds to Step S56.

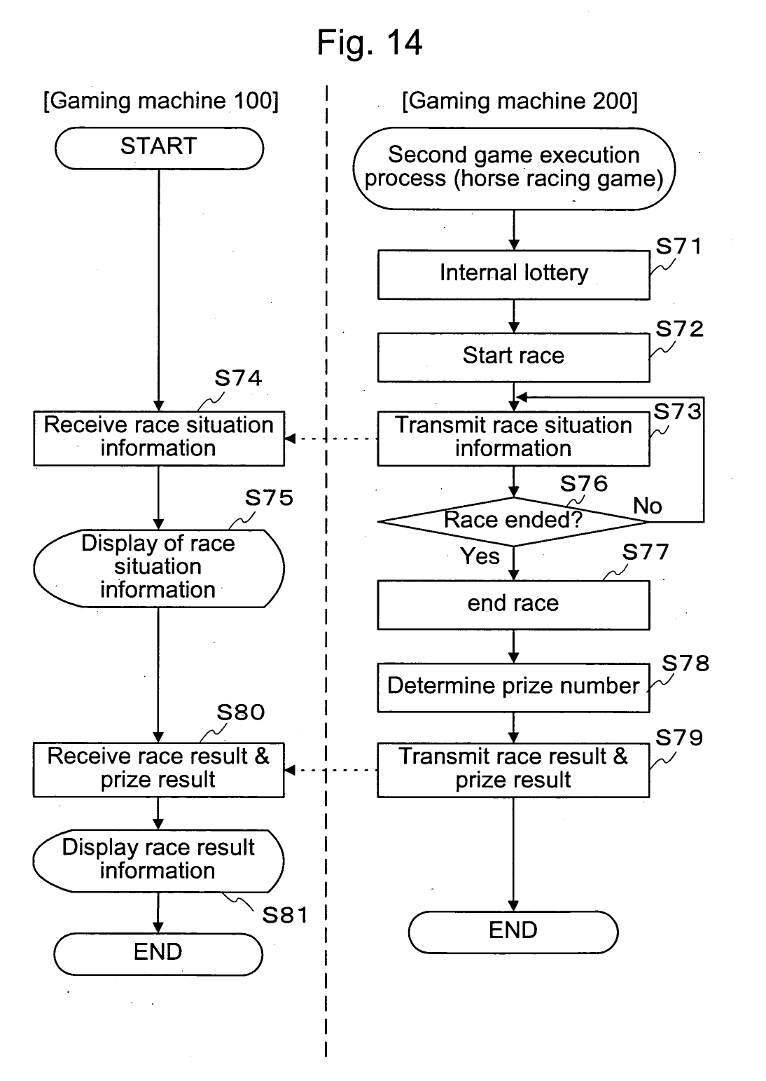

In the gaming machine 200, on the other hand, the operation of Step S55 is executed after the end of the operation of Step S54 in the gaming machine 100. In short, the second game process is executed. In this process, the second game process is executed by the control of the CPU 202 of the gaming machine 200. The process of the case, in which the second game is the horse racing game, will be detailed in the subroutine of the second game execution process (i.e., the horse racing game), as shown in FIG. 14. In the subroutine of the second game execution process, the execution result of the second game (i.e., the horse racing game) is obtained, and the prize to be given is determined on the basis of the execution result and the BET information made by each player. The signal of the information on the prize is transmitted to the gaming machine 100. After this operation ends, the subroutine proceeds to Step S58 in the gaming machine 200.

In the gaming machine 100, on the other hand, the operation of Step S56 is executed to determine the presence/absence of the prize on the basis of the information on the prize, which has been transmitted from the gaming machine 200 at the Step S55 executed in the gaming machine 200. In this operation, the CPU 132 of the gaming machine 100 determines the presence/absence of the prize with reference to the variables arranged in the RAM 134 for storing the information on the prize. The subroutine proceeds to Step S57, in case the presence of the prize is determined, but otherwise to Step S59.

Next at Step S57, the prize is given to the player because the presence of the prize has been determined at Step S56. In this operation, the CPU 132 of the gaming machine 100 determines the prize number with reference to the variables arranged in the RAM 134 and storing the information on the prize, and transmits the signal on the instruction to pay out the coins and on the number of coins, to the main control circuit 101 of the first game of the gaming machine 100 through the communication control circuit 135 so that the coins of the number corresponding to the prize may be paid out. The communication control circuit 130 of the main control circuit 101 of the first game of the gaming machine 100, which has detected the reception of that signal, feeds the CPU 102 of the main control circuit 101 with the signal on the prize instruction and number of the coins. The CPU 102 of the gaming machine 100 having received the feed of that signal adds the CREDIT number to the upper limit, and feeds the hopper driving circuit 118 with the signal to instruct the payout of the coins for the excess prize. The hopper 119 pays out the coins actually. For this payout of the coins, the coin detection unit 121 counts the number of coins paid out. When the coin detection unit 121 detects that the predetermined number of coins to be paid out is reached, it feeds the detection signal to the completion signal circuit 120. This completion signal circuit 120 feeds, when fed with that signal, the CPU 102 with the signal to stop the payout. The CPU 102 feeds, when fed that payout stop signal, the hopper driving circuit 118 with the signal to stop the payout of the coins. The hopper driving circuit 118 stops, when fed with that signal, the drive of the hopper 119 so that the coin payout ends. When this operation ends, the subroutine proceeds to Step S59.

In the gaming machine 200, on the other hand, the operation of Step S58 is executed after the end of the operation of Step S57 in the gaming machine 100. In this operation, the BET operation acceptance start notification information is transmitted. Specifically, the process of the game in the gaming machine 200 has ended. Therefore, the BET operation in the operation display 150 or 156 of the liquid crystal display 138 of the gaming machine 100 can be accepted till the next execution of the game. The CPU 202 of the gaming machine 200 transmits the signal of the BET operation acceptance start notification information to the gaming machine 100 through the communication control circuit 218. When this operation ends, the process of this subroutine in the gaming machine 200 ends.

In the gaming machine 100, on the other hand, the BET acceptance start notification information transmitted at. Step S58 from the gaming machine 200 is received at Step S59. The communication control circuit 135 of the gaming machine 100 feeds, when it detects the reception of that information signal, the detected signal to the CPU 132. When this operation ends, the subroutine proceeds to Step S60.

Next at Step S60, the BET operation acceptance is started. In this operation, the CPU 132 is based on that signal to feed the liquid crystal driving circuit 137 with a signal to instruct the operation acceptance start of the operation display 150 or 156, which is disposed in the liquid crystal display 138. The liquid crystal driving circuit 137 fed with the instruction signal cancels the stopping order of the operation acceptance on the operation display 150 or 156 of the liquid crystal display 138. After this operation ends, the subroutine proceeds to the operation of Step S61.

Next at Step S61, the BET operation acceptance start is displayed. In this operation, the display of the BET operation acceptance start is executed as the stopping order of the operation acceptance on the operation display of the liquid crystal display 138 having executed at Step S60 is cancelled. It is displayed in the liquid crystal display 138 on the basis of the signal fed by the liquid crystal driving circuit 137 that the BET operation of the operation display of the liquid crystal display 138 can be accepted. In the display screen of the liquid crystal display 138 shown in FIG. 15, for example, it is displayed by changing the display of the display 153 from “NOW RACE” to “NOW BET” that the BET operation of the operation display of the liquid crystal display 138 can be accepted. When this operation ends, this subroutine ends.

### SECOND GAME EXECUTION AND TRANSMISSION/RECEPTION OF DATA ON THE EXECUTION

Next, a subroutine, in which communications are made between the gaming machine 100 and the gaming machine 200 to control the second game execution and the transmission/reception of data of the second game, is shown in FIG. 14.

With reference to FIG. 14, first of all, the operation of Step S71 is executed in the gaming machine 200. This operation is an internal lottery of the horse racing game in the gaming machine 200. On the basis of the BET information of each player stored in the variables arranged in the RAM 205 and the random numbers to be drawn, the result of the horse race is determined. In this embodiment, the random number generator 208 of the gaming machine 200 generates random numbers within a range of 0 to 16383 (=214) patterns, and the random number sampling circuit 209 samples one random number and feeds the sampled random number to the CPU 202. This CPU 202 stores the internal lottery data based on that random number, in the variables arranged in the RAM 205. In case this operation ends, the subroutine proceeds to Step S72.

Next at Step S72, the horse race start is executed. The start execution, as called so herein, means preparations for converting the image to be transmitted as a relay image of the race situations to the gaming machine 100 while supporting the situations the horse race, into data and for transmitting the converted data to the gaming machine 100. In this operation, the CPU 202 of the gaming machine 200 reads the image data recorded in the ROM 203 to synthesize proper image for the transmission and stores the synthesized result in the RAM 205. When this operation ends, the subroutine proceeds to Step S73.

Next at Step S73, the race situation information is transmitted. In this operation, the image data, which are synthesized and stored at Step S72 and optimized for displaying the race situations, are continuously transmitted to the gaming machine 100. The CPU 202 of the gaming machine 200 transmits the image data stored in the RAM 205, through the communication control circuit 218 to the gaming machine 100. When this operation ends, the gaming machine 200 proceeds the operation to Step S76.

At Step S74 in the gaming machine 100, on the other hand, the image data transmitted from the gaming machine 200 are received. In this operation, when the communication control circuit 135 of the gaming machine 100 detects the reception of the signal of the image data, it feeds the detection signal to the CPU 132. When this operation ends, the subroutine proceeds to Step S75.

Next at Step S75, the CPU 132 having received the feed of the detection signal from the communication control circuit 135 of the gaming machine 100 feeds the liquid crystal driving circuit 137 with the signal instructing the display based on the image data to the liquid crystal display 138. The liquid crystal driving circuit 137 fed with that instruction signal displays the display based on the image data in the liquid crystal display 138. When this operation ends, the gaming machine 100 proceeds to Step S80.

In the gaming machine 200, on the other hand, it is determined at Step S76 whether or not the race has ended. The subroutine proceeds to Step S77, in case the CPU 202 determines that the race has ended, but otherwise returns to Step S73. Thus, the operation of Step S73 is continued till the transmission of all the image data ends.

Next at Step S77, the race is ended. In this operation, the variables used for synthesizing the image data at Step S72 and arranged in the RAM 205 are initialized, and the storage areas are initialized. The CPU 202 initializes the variables arranged in the RAM 205 and the storage areas. When this operation ends, the subroutine proceeds to Step S78.

Next at Step S78, the prize number is determined. In this operation, on the basis of the race result determined at Step S71, the CPU 202 of the gaming machine 200 determines the prize number to be given to each player, and the determined prize number is stored in the variables stored in the RAM 205. When this operation ends, the subroutine proceeds to Step S79.

Next at Step S79, the race result determined at Step S71 and the prize result determined at Step S78 are transmitted to the gaming machine 100. In this operation, the CPU 202 of the gaming machine 200 reads out the variables, which are arranged in the RAM 205 and store the information on the race result and the prize result, and transmits that information through the communication control circuit 218 to the gaming machine 100. When this operation ends, this subroutine ends in the gaming machine 200.

At Step S80 in the gaming machine 100, on the other hand, the information on the race result and the prize result transmitted at Step S79 by the gaming machine 200 is received. In this operation, the communication control circuit 135 of the gaming machine 100 feeds, when it detects the reception of the signal of that information, the detection signal to the CPU 132. When this operation ends, the operation proceeds to Step S81.

Next at Step S81, the information on the race result and the prize result received at Step S80 is displayed in the liquid crystal display 138 of the gaming machine 100. In this operation, the CPU 132 of the gaming machine 100 fed with the detection signal of the information signal of the race result and the prize result feeds the liquid crystal driving circuit 137 with a signal to instruct the display based on that received signal. The liquid crystal driving circuit 137 fed with that signal instructs the liquid crystal display 138 to display on the basis of the information signal of the race result and the prize result. When this operation ends, this subroutine ends.

### DISPLAY ON SECO9ND DISPLAY DEVICE OF GAMING MACHINE 100

FIG. 15 presents a display image of the second game (i.e., the horse racing game) to be displayed in the second display device of the gaming machine, i.e., in the liquid crystal display 138.

The operation display 150 allows, when each of its generally rectangular operation displays is touched, the player to bet a desired winning horse. At each time the generally rectangular operation display unit is once touched, the number of coins to be bet increases one by one at the time of betting the winning horse of each pattern. The betting patterns are: “WIN” to bet a horse; “Quinella” to bet two-horse combination in the first and second ranks for a quiniela; and “Exacta” to bet two horses in the exact first and second ranks for an exacta.

A display 151 displays the race result of the horse race. In this display screen, the race is held with six horses so that the race order of first to sixth is displayed by the horse numbers.

A display 152 displays the race situations when the horse race is being held. The display image on the display 152 in the racing time is identical to that which is displayed in the display device 216 of the horse racing game body of FIG. 7.

The display 153 displays either the “NOW BET” or the “NOW RACE”. When the “NOW BET” is displayed, the operation display 150 can be operated. When the “NOW RACE” is displayed, the race situations are displayed in the display 152 so that the operation display 150 cannot be operated.

A display 154 displays the number of coins credited in the gaming machine. This display is identical to the CREDIT display on the display device 128 of the gaming machine 100.

A display 155 displays the total of the prizes obtained from the race result by the BET in the display screen.

The operation display 156 is an operation display for the so-called “BOXBET”.

A display 157 displays the sum of the numbers of coins, which have been bet by the player's operation of the operation display 150 or 156.

By thus configuring the gaming machines to perform the operations, the player of the slot game is enabled to participate in the horse racing game at the gaming machine for the slot game without moving to the gaming machine of the horse racing game installed at another place. As a result, the participation of the slot game player in the horse racing game can be promoted to improve the selectivity of the game by the slot game player thereby to enhance the working efficiency of the entire gaming place. Moreover, it is possible to provide opportunities for more players to participate in the horse racing game.

### SECOND EMBODIMENT

A second embodiment of the invention will be described with reference to the accompanying drawings.

The second embodiment presents the case, in which the first game of the invention is the “slot” in which the second game is the “roulette”.

### NETWORK CONFIGURATION DIAGRAM OF SECOND EMBODIMENT

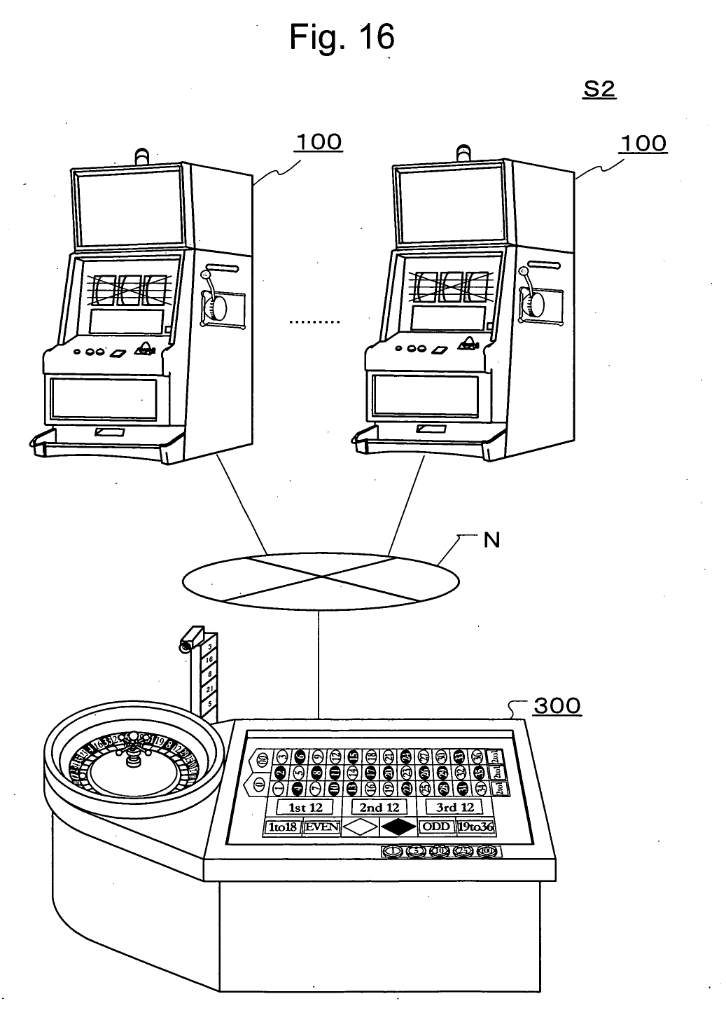

A gaming system S2 shown in FIG. 16 is composed of a network N, a plurality of gaming machines 100, and a gaming machine 300.

The gaming machines 100 and the gaming machine 300 in the second embodiment are placed at each gaming place and operated by the players. The gaming machines 100 are slot machines like those of the (first) embodiment, and the gaming machine 300 is the general roulette game, in which a plurality of players can participate. The components and functions of the gaming machine 300 will be described hereinafter.

### OUTLINE OF GAMING MACHINE 300

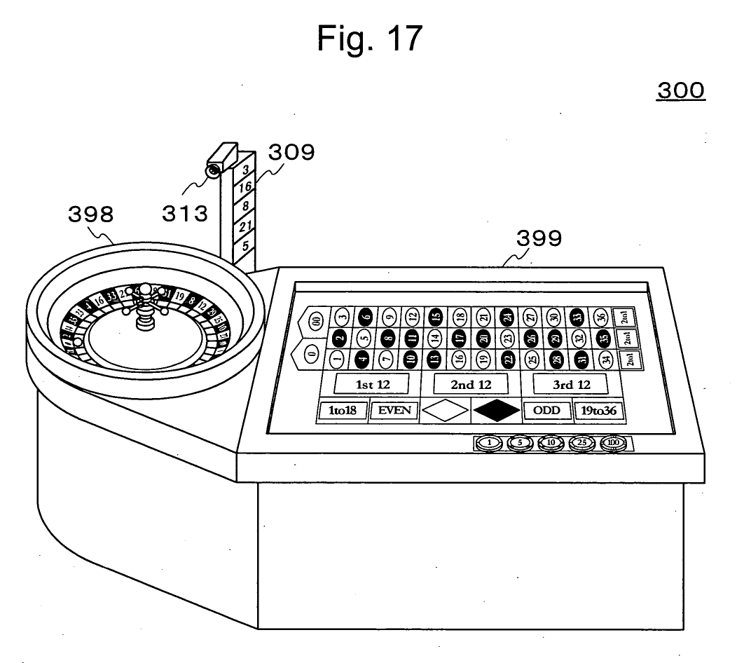

The schematic perspective view of the gaming machine 300 of the second embodiment is shown in FIG. 17.

The gaming machine 300 is one for playing the roulette game and has a cabinet 399 for the roulette game. This cabinet 399 is configured to include: a roulette device 398; a CCD (Charge Coupled Device) camera 313 for photographing the overall view of the roulette device downward; and a display device 309 for displaying the roulette game result of a predetermined latest number (e.g., five times in this embodiment).

### ELECTRIC CONFIGURATION OF GAMING MACHINE 300

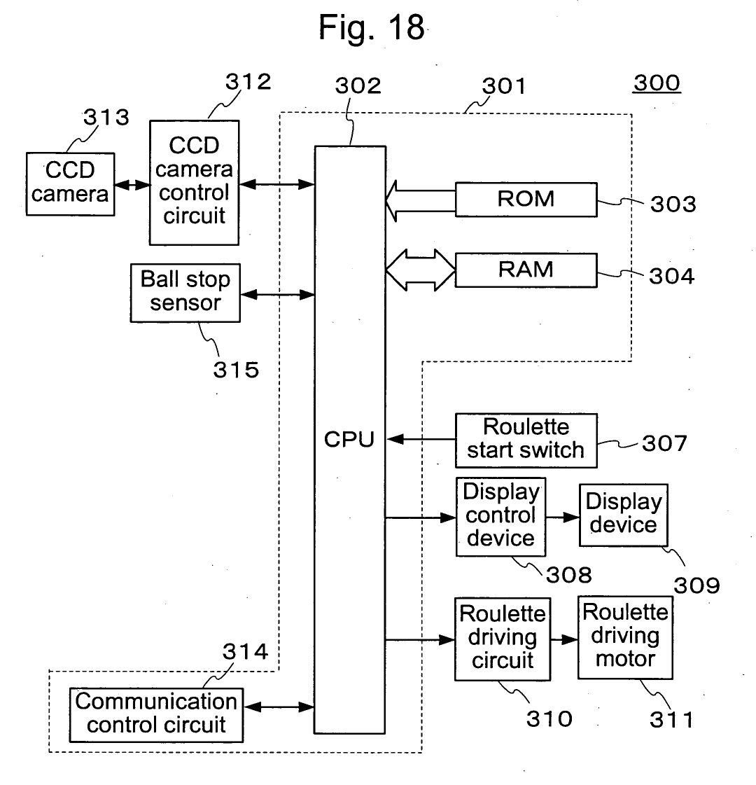

FIG. 18 is a hardware block diagram of the gaming machine 300.

A portion enclosed by broken lines in FIG. 18 is a main control circuit 301 of the gaming machine 300. This main control circuit 301 configures the second game control means and includes: a CPU 302 for control operations according to preset programs; a ROM 303 and a RAM 304 as storage means; and a communication control circuit 314.

The ROM 303 records various control programs for controlling the gaming machine 300. Moreover, the ROM 303 stores initial data for executing the control programs, and programs for performing the display control in the display device 309. Moreover, the ROM 303 is stored with the various control instructions (or commands) for transmitting signals to the various peripheral devices.

The RAM 304 stores the values of flags or variables to be used in the various control programs, temporarily.

The various peripheral circuits are connected with the CPU 302 through a predetermined interface circuit group (not-shown).

A roulette start switch 307 is connected with the CPU 302 through the interface circuit group. This roulette start switch 307 is operated by the dealer of the roulette to feed a roulette start signal to the CPU 302 at the timing of the switch operation.

Moreover, a display control device 308 is connected with the CPU 302 through the interface circuit group. The display control device 308 controls the display device 309 connected therewith, when it accepts a numeral display instruction signal fed from the CPU 302.

Moreover, a roulette driving circuit 310 is connected with the CPU 302 through the interface circuit group. This roulette driving circuit 310 controls a roulette driving motor 311 connected therewith, when it accepts a roulette drive instruction signal fed from the CPU 302.

Moreover, a CCD control circuit 312 is connected with the CPU 302 through the interface circuit group. This CCD control circuit 312 controls the CCD camera 313 connected therewith, when it accepts a CCD control signal fed from the CPU 302.

Still moreover, a ball stop sensor 315 is connected with the CPU 302 through the interface circuit group. This ball stop sensor 315 is arranged in the bottom portion of each lattice disposed in the vicinity of a numeral display of the roulette device for stopping the ball, and detects the position, at which the ball of the roulette stops. The ball stop sensor 315 detects the position, at which the ball of the roulette stops, and feeds the information of the stop position to the CPU 302.

Here, the configuration may not be provided with that ball stop sensor. In a modification, for example, the ball is rolled by the spin of the roulette, and the ball stop position is visually confirmed by the dealer. Then, the stop number of the ball is input from an input device, which is connected through the interface circuit group to input the ball stop number.

### OPERATIONS OF GAMINE MACHINE

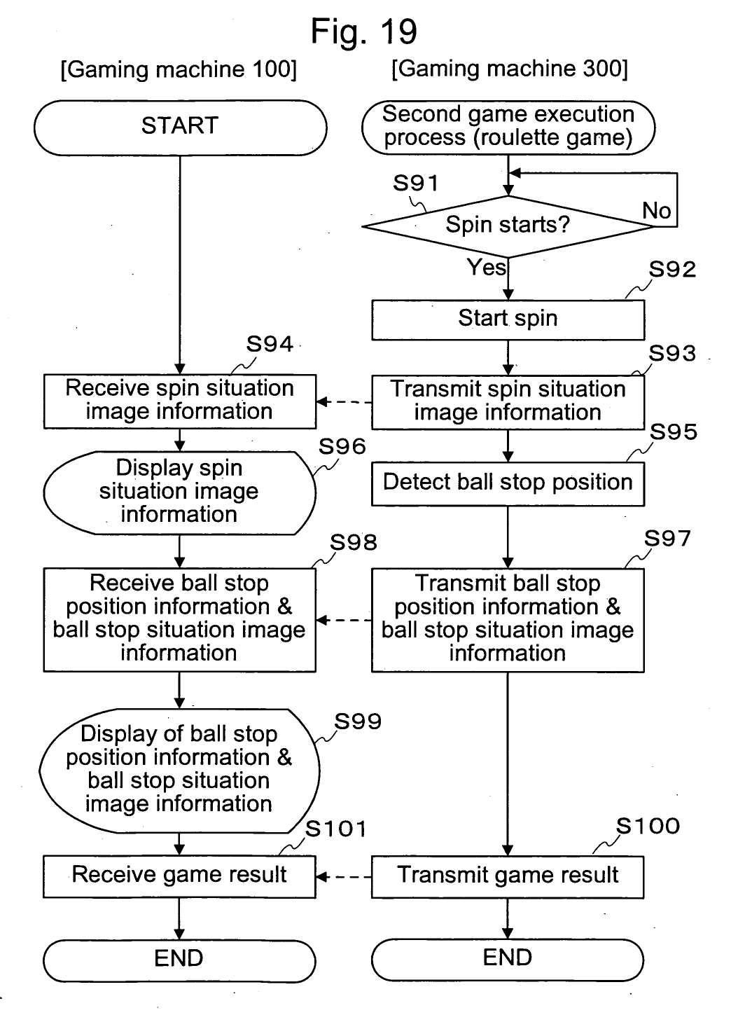

The operations of the gaming machine of the second embodiment are similar to those of the first embodiment. However, the subroutine to be called at the second game execution process in FIG. 13 is different. Therefore, the process of the second play execution (i.e., the roulette game) will be described with reference to FIG. 19.

First of all, at Step S91, the CPU 302 of the gaming machine 300 determines whether or not the roulette start switch 307 has been operated by the dealer and whether or not the operation signal has been fed to the CPU 302. In case it is determined that the roulette start switch has been operated and that the operation signal has been fed to the CPU 302, the subroutine proceeds to Step S92. Otherwise, the operation of Step S91 is executed again.

Next at Step S92, the spin starting operation is performed. In this operation, the CPU 302 is fed with the operation signal of the roulette start switch 307, and the roulette driving circuit 310 drives the roulette driving motor 311 thereby to start the spin. When this operation ends, the subroutine proceeds to Step S93.

Next at Step S93, spin situation image information is transmitted. In this operation, the CPU 302 of the gaming machine 300 starts the feed of a photography instruction signal of the CCD camera 313 to the CCD control circuit 312. The CCD control circuit 312 having received that signal starts the feed of the photography instruction signal to the CCD camera 313, and the CCD camera 313 having received that signal starts the photography of the overall view of the roulette device. The CPU 302 fed with the photographic data through the CCD control circuit 312 converts the photographic data into signals, and transmits the signals to the gaming machine 100 through the communication control circuit 314. When this operation ends, the operation proceeds to Step S95 in the gaming machine 300.

In the gaming machine 100, on the other hand, the spin situation image information transmitted at Step S93 of the gaming machine 300 is received at Step S94. In this operation, the communication control circuit 135 (FIG. 6) detects the reception of that signal and feeds the detection signal to the CPU 132. When this operation ends, the subroutine proceeds to Step S96 in the gaming machine 100.

Next at Step S96, the spin situation image information is displayed. In this operation, on the basis of the spin situation image information received at Step S94, the CPU 132 of the gaming machine 100 feeds the image display signal to the liquid crystal driving circuit 137 so that the liquid crystal driving circuit 137 fed with that signal displays the image based on that information. When this operation ends, the subroutine proceeds to Step S98 in the gaming machine 100.

At Step S95 in the gaming machine 300, on the other hand, the ball stop position is detected. The ball stop sensor 315 (FIG. 18) of the gaming machine 300 detects the stop position of the ball of the roulette. When this operation ends, the subroutine proceeds to Step S97 in the gaming machine 300.

Next at Step S97, the ball stop position information and the ball stop situation image information are transmitted. In this operation, the CPU 302 is fed with the signal of the information of the ball stop position, which has been detected at Step S95 by the ball stop sensor 315 of the gaming machine 300, and the ball stop situations photographed by the CCD camera 313 are fed as the photographic signal to the CPU 302 through the CCD camera control circuit 312. The CPU 302 fed with that signal transmits the signal to the gaming machine 100 through the communication control circuit 314. When this operation ends, the subroutine proceeds to Step S100 in the gaming machine 300.

At Step S98 in the gaming machine 100, on the other hand, the ball stop position information and ball stop situation image information transmitted at Step S97 of the gaming machine 300 are received. In this operation, the communication control circuit 135 (FIG. 6) detects the reception of that signal and feeds the detection signal to the CPU 132. When this operation ends, the subroutine proceeds to Step S99 in the gaming machine 100.

Next at Step S99, the ball stop position information and the ball stop situation image information are displayed. In this operation, the ball stop position information and the ball stop situation image information received at Step S98, the CPU 132 of the gaming machine 100 feeds the image display signal to the liquid crystal driving circuit 137 so that the liquid crystal display 138 fed with that signal displays the image based on that information. When this operation ends, the subroutine proceeds to Step S101 in the gaming machine 100.

At Step S100 of the gaming machine 300, on the other hand, the game result is transmitted. In this operation, the information on the ball stop position detected by the ball stop sensor 315 and the information on the prize number are fed to the CPU 302 and are further fed to the display control device 308 so that those pieces of information are displayed in the latest ball stop number display of the display device 309 of the gaming machine 300. At the same time, the signals of the information on the ball stop position and the information on the prize number are fed to the gaming machine 100. When this operation ends, the subroutine ends in the gaming machine 300.

At Step S101 in the gaming machine 100, on the other hand, the game result is received. In this operation, the communication control circuit 135 of the gaming machine 100 receives the signals of the information on the ball stop position and the information on the prize number, which have been transmitted at Step S100 of the gaming machine 300 to the gaming machine 100, and feeds the detection signal to the CPU 132. The CPU 132 having received the feed of that signal feeds through the communication control circuit 135 either the increase/decrease information of the CREDIT on the basis of the information signal on the prize to the main control circuit 101 of the first game of the gaming machine 100 or the coin payout instruction signal to the hopper driving circuit 118 in the case of the prize exceeding the CREDIT upper limit. In the main control circuit 101 of the gaming machine 100 having received that signal through the communication control circuit 130, the CPU 102 feeds the coin payout signal to the hopper driving circuit 118 so that the hopper driving circuit 118 fed with that coin payout signal drives the hopper 119 to pay out the coins. The coin detection unit 121 counts a predetermined number of coins and feeds the payout completion signal to the payout completion signal circuit 120. This payout completion signal circuit 120 having received that payout completion signal feeds the payout completion signal to the CPU 102. This CPU 102 receives the feed of the payout completion signal and feeds the payout completion signal to the hopper driving circuit 118. Thus, the payout of the coins ends. On the other hand, the CPU 132 feeds the liquid crystal driving circuit 137 with the instruction signal to instruct the liquid crystal display 138 to display the information corresponding to the information on the ball stop position and the information on the prize number. In case the CREDIT increases/decreases on the basis of the information on the prize number, moreover, the CPU 132 updates the CREDIT information and feeds the signal of the display instruction to the liquid crystal driving circuit 137. The liquid crystal display 138 having received the feed of that instruction signal displays the information on the stop position, the information on the prize number, and the CREDIT information updated. When this operation ends, the subroutine ends.

### DISPLAY ON SECOND DISPLAY DEVICE OF GAMING MACHINE 100 IN SECOND EMBODIMENT

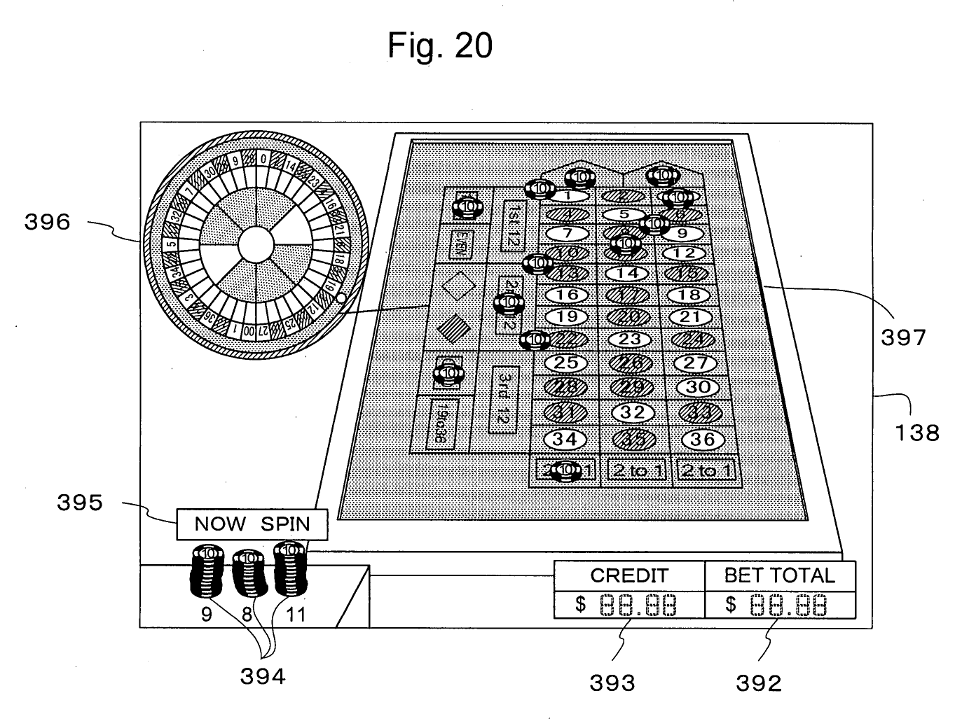

FIG. 20 is a display image diagram of the second game (i.e., the roulette game) of a second embodiment displayed in the second display device, i.e., the liquid crystal display 138 of the gaming machine.

An operation display 397 is a cellular display according to an actual roulette table for betting coins. Here is adopted the touch-panel method. The player touches the coins displayed in an operation display 394, one by one, and drags those coins in the operation display 397 to a desired bet position thereby to place the coins to be bet on a desired bet position.

A display 396 presents an image of the overall view of the roulette of an actual roulette table, which is photographed by the CCD camera 313. While the roulette is spinning, the latest image of the roulette is displayed in the display 396 so that the player can confirm the stop position of the ball visually.

A display 395 displays either “NOW BET” or “NOW SPIN”. When the “NOW BET” is displayed, the display 396 disappears so that the player can bet. When the “NOW SPIN” is displayed, the display 396 appears so that the player cannot be bet.

When the player bets coins, these coins are dragged by the touch from the operation display 394 to the desired bet position.

A display 393 displays the number of coins credited in the gaming machine. This display is identical to the CREDIT display in the display device 128 of the gaming machine 100.

A display 392 displays the total of the coin numbers, which have been bet by the player through the operation displays 394 and 397.

By thus configuring the gaming machines to perform those operations, the player of the slot game is enabled at the slot gaming machine to participate in the roulette game without moving to the roulette game table installed at another place. As a result, the participation of the slot game player in the roulette game can be promoted to improve the selectivity of the game by the slot game player thereby to enhance the working efficiency of the entire gaming place. Moreover, it is possible to provide opportunities for more players to participate in the roulette game.

### THIRD EMBODIMENT

A third embodiment of the invention will be described with reference to the accompanying drawings.

According to the third embodiment of the present invention, a gaming system is disclosed, in which the first game is the “video poker” and the second game is the “keno” game.

### NETWORK CONFIGURATION DIAGRAM OF THIRD EMBODIMENT

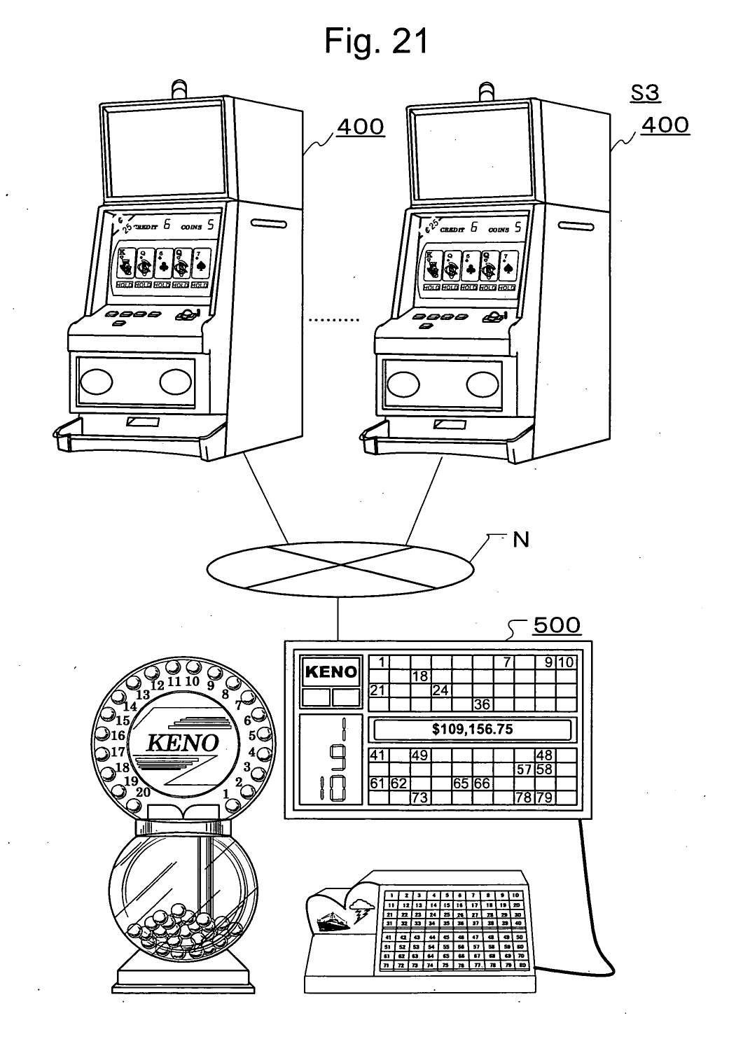

A gaming system S3 shown in FIG. 21 is configured of a network N, a plurality of gaming machines 400 and a gaming machine 500.

The gaming machines 400 and the gaming machine 500 in the third embodiment are placed at each gaming place and operated by the players. The gaming machines 400 are the general “video poker” machines, and the gaming machine 500 is the general “keno” game, in which a plurality of players can participate. The components and functions of the gaming machine 500 will be described hereinafter.

### OUTLINE OF GAMING MACHINE 400

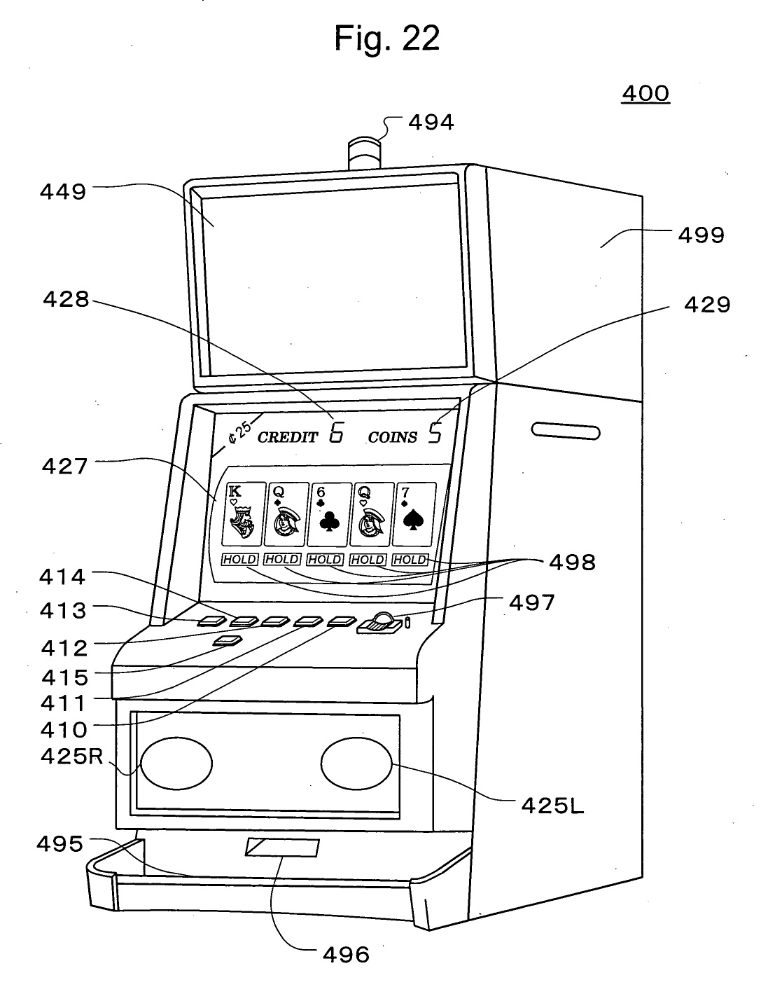

The schematic perspective view of the gaming machine 400 of the third embodiment is shown in FIG. 22.

A cabinet 499 constituting the entirety of the gaming machine 400 is provided with a main display device 427.

In this main display device 427, five cards are displayed separately in sections, as shown in FIG. 22. These cards are so displayed according to the rules of the poker game that they are started with face down at the game starting time and are sequentially turned with face up as the poker game proceeds.

Five touch-panel type “HOLD” operation displays 498 are displayed in the screen of that main display device 427.

These five “HOLD” operation displays 498 are displayed one by one at positions below the sections of the five cards displayed in the main display device 427.

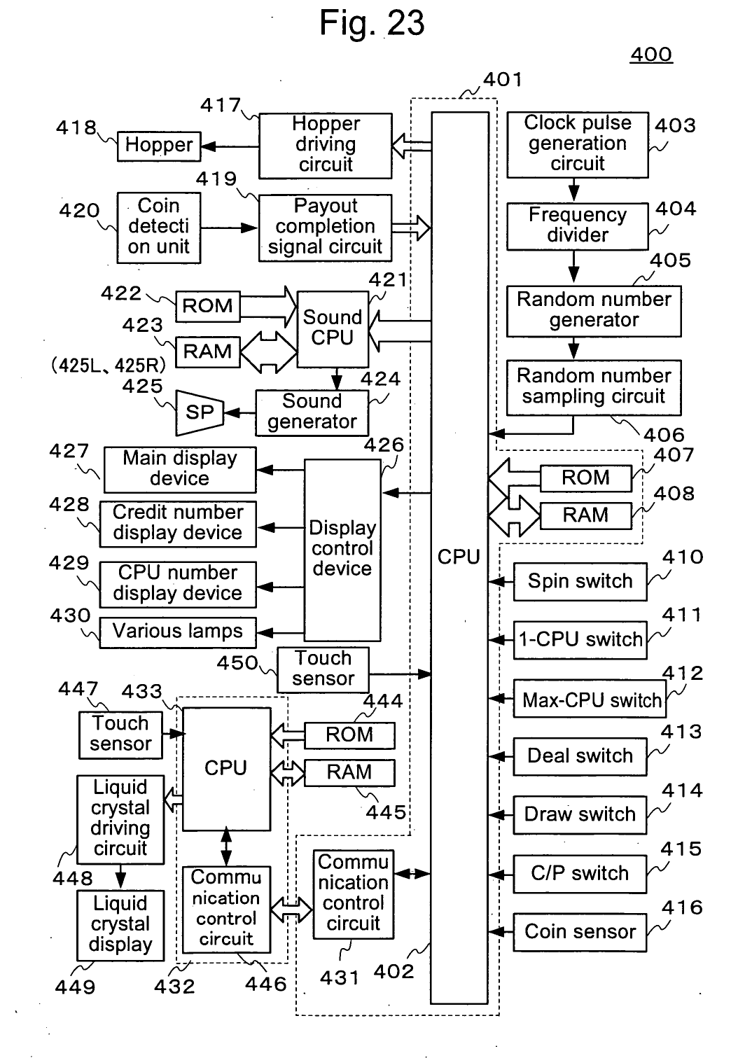

When those five “HOLD” operation displays 498 are touched by the player, a touch sensor 450 (FIG. 23) of the gaming machine 400 detects the touches and feeds the detection signals to a CPU 402 of the gaming machine 400. These five “HOLD” operation displays 498 are used to select the cards to be held (or not exchanged), when the cards are dealt.

Here in the invention, those five “HOLD” operation displays 498 should not be limited to the touch-panel type, but five switches may also be disposed in the vicinity of the later-described various switches, which are arranged on the front face of the cabinet 499.

Moreover, a CREDIT number display device 428 for displaying a CREDIT number and a BET number display device 429 for displaying a BET number are disposed above the main display device 427.

These CREDIT number display device 428 and the BET number display device 429 display the coin number credited and the coin number bet in the gaming machine 400 by the player.

Still moreover, a liquid crystal display 449 is disposed as the second display device above the CREDIT number display device 428 and the BET number display device 429.

In the third embodiment, the main display device 427, the CREDIT number display device 428 and the BET number display device 429 are made of an LCD. However, the main display device 427, the CREDIT number display device 428 and the BET number display device 429 in the invention should not be limited thereto, but may also be configured of a plurality of one or a plurality of kinds of display devices by using a CRT (Cathode Ray Tube) display, a plasma display, a seven-segment display, a dot matrix display, a lamp, an LED (Light Emitting Diode), a fluorescent lamp, an EL (Electronic Luminescence) display, a reel, or a disk.

A tower light 494 is disposed at the uppermost position of the cabinet 499. This tower light 494 is turned on in case a predetermined winning combination of the poker holds. The tower light 494 is a kind of lamp included in various lamps 430 to be controlled by a display control device 426 (FIG. 23) under the control of the CPU 402 (FIG. 23) of the gaming machine 400.

The cabinet 499 is provided on its front face with: a coin insertion slot 497, into which coins to be bet on the poker game are inserted by the player; a spin switch 410 stored with the BET number of the previous play for setting the BET number on the basis of the stored information; a 1-BET switch 411 for setting those of the inserted coins or the credited coins one by one which are to be bet on the poker game; a MAX-BEt switch 412 for likewise setting those of the inserted coins or the credited coins to the betting upper limit which are to be bet on the poker game; a DEAL switch 413 for starting the poker game actually when the bet coin number is determined; a DRAW switch 414 for starting the operation to exchange the cards, for which the HOLD buttons have not been pressed, after the HOLD operation; and a C/P switch 415 for instructing the payout of the CREDIT coins.

The cabinet 499 is provided with speakers 425 (425R and 425L) at a lower portion of its front face. Sounds for predetermined game effects are issued from those speakers 425.

The cabinet 499 is provided at the lowermost position of its front face with a coin payout opening 496 for paying out the coins, and a coin tray 495 for receiving the coins paid out. These coins are paid out from the coin payout opening 496 when the CREDIT reaches the upper limit or when the C/P switch 415 is operated.

### ELECTRIC CONFIGURATION OF GAMING MACHINE 400

FIG. 23 is a hardware block diagram of the gaming machine 400.

With reference to FIG. 23, the gaming machine 400 is coarsely configured to include a main control circuit 401 for controlling the first game (e.g., the video poker), and a control circuit 432 for controlling the image display of the second game (e.g., the keno game).

In the gaming machine 400, the control is made on the first game (i.e., the video poker) but not on the second game (i.e., the keno game). Specifically, the control for executing the second game is made by the gaming machine 500, and what is performed by the control circuit 432 of the gaming machine 400 is to receive pieces of information concerning the image data on the game, the data on the BET and the game result of the gaming machine 200 from the gaming machine 500, and to control and display the information based on those pieces of information.

A first portion enclosed by broken lines in FIG. 23 is the first game of the gaming machine 100, that is, the main control circuit 401 of the “video poker” game. This main control circuit 401 includes: a CPU 402 for performing control operations according to preset programs; a ROM 407 and a RAM 408 acting as storage means; and a communication control circuit 431.

The ROM 407 stores control programs for controlling the flow of the entire game of the gaming machine. Moreover, the ROM 407 stores initial data for executing control programs, programs for controlling the flashing operation patterns of various lamps 129, and programs for display controls in the main display device 427, the CREDIT number display device 428 and the BET number display device 429. Further stored are a probability lottery table to be used for deciding a sampling random number each time the DEAL switch 413 or the DRAW switch 414 is operated, a display control table for determining the display mode of the five cards to be displayed in the main display device 427 according to that sampling random number, and various control instructions (or commands) for transmitting signals to various peripheral devices.

Here, the programs in this embodiment are stored in the ROM 407. In the invention, however, the programs can cause the CPU 402 to execute the various operations as procedures, means or functions. The programs may also be stored in recording media, which can be read out by various reading devices connected with the CPU 402, such as a hard disk device, a CD-ROM or a DVD. Moreover, these programs need not be stored in proceed but may be stored in the RAM 408 or the like after the power is turned On. Still moreover, the individual programs may be stored in different storage media.

The RAM 408 stores the aforementioned program body and stores the values of flags and variables to be used in the programs.

The various peripheral devices are connected with the CPU 402 through a predetermined group of interface circuits (not-shown).

A random number sampling circuit 406 is connected with the CPU 402.

A random number generator 405 is connected with the random number sampling circuit 406, and the random numbers to be generated for a constant period by the random number generator 405 are sampled by the random number sampling circuit 406 so that their information is fed to the CPU 402.

In order that pulses for the constant period may be fed to the random number generator 405 to generate the random numbers for the period in the random number generator 405, a frequency divider 404 is connected with the random number generator 405, and a clock pulse generation circuit 403 is connected with the frequency divider 404. With this configuration, the random numbers are generated in the clock pulse generation circuit 403 with the pulses independent of the main control circuit 401 of the gaming machine 400. The clock pulse generation circuit 403 generates pulses having a frequency independent of the main control circuit 401 of the gaming machine 400, inputs the pulses into the frequency divider 404 and divides the pulses, and generates the random numbers in the random number generator 405 on the basis of the frequency-divided pulses.

In this embodiment, the gaming machine 400 is configured to include the random number generator 405, and the random numbers generated from the random number generator 405 are stored in the RAM 408 by the CPU 402. However, this invention should not be limited to that storage, but the CPU 402 may generate the random numbers on the basis of the programs stored in the ROM 407.

A coin sensor 416 is disposed in the vicinity of the coin insertion slot 497 (FIG. 22) and connected with the CPU 402. This coin sensor 416 feeds the CPU 402 with an inserted-coin calculation signal for detecting that the coins are inserted into the coin insertion slot 497.

Moreover, the spin switch 410, the 1-BET switch 411 and the MAX-BET switch 412 are connected with the CPU 402. The BET signals are fed to the CPU 402 when the spin switch 410, the 1-BET switch 411 and the MAX-BET switch 412 are operated by the player.

Here, the “BET” means that “the coins are bet” in the game.

Moreover, the DEAL switch 413 and the DRAW switch 414 are connected with the CPU 402. When these switches are pressed by the player, a DEAL signal or a DRAW signal is fed from those switches to the CPU 402 so that the cards to be dealt to the player are determined and displayed in the main display device 427.

Here, in the poker game, the DEAL is a first operation to deal the cards, and the DRAW is an operation to exchange those of the dealt cards which are not held.

Still moreover, the C/P switch 415 is connected with the CPU 402. On the operation of the player, the C/P switch 415 feeds the C/P signal to the CPU 402.

Moreover, a sound CPU 421 is connected with the CPU 402. The sound CPU 421 generates sounds from the speakers 425 (425L and 425R) when it receives a sound generation instruction signal fed from the CPU 402.

A ROM 422, a RAM 423 and a sound generator 424 are connected with the sound CPU 421. Moreover, the speakers 425 (425L and 425R) are connected with the sound generator 424.

The ROM 422 is stored with sound data. When the sound CPU 421 receives the aforementioned sound generation instruction signal, it reads out the sound data based on that signal, from the ROM 422. Here, the sound CPU 421 stores the RAM 423 temporarily with the data fed from the CPU 402 and the sound data read from the ROM 422. Moreover, the sound CPU 421 feeds the read sound data to the sound generator 424 at a predetermined timing, which generates sounds by converting the sound data into predetermined signals and by feeding these signals to the speakers 425.

Moreover, a display control device 426 is connected with the CPU 402. When the display control device 426 receives an image display instruction signal from the CPU 402, it controls the main display device 427, the CREDIT number display device 428, the BET number display device 429 and the Various lamps 430, which are connected with the display control device 426. Here, these various lamps 430 contain the tower light 494 (FIG. 22).

Moreover, a hopper driving circuit 417 is connected with the CPU 402, and a hopper 418 is connected with the hopper driving circuit 417. In the mode indicating the winning mode of an internal winning combination, the CPU 402 feeds a payout instruction signal to the hopper driving circuit 417 so that a predetermined number of coins are paid out from the hopper 418. At this time, a coin detection unit 420 counts the number of coins to be paid out from the hopper 418, and feeds a coin payout completion signal to a payout completion signal circuit 419 when the counted value reaches a designated number. Then, the payout completion signal circuit 419 feeds that coin payout completion signal to the CPU 402. Here, the gaming machine 400 of this embodiment can credit five hundreds coins and pays out the coins unconditionally when the coin number exceeds five hundreds. Moreover, the coins are also paid out when the C/P switch 402 feeds the C/P signal to the CPU 402, as described above. As a result, the CPU 402 stops the drive of the hopper 418 through the hopper driving circuit 417 and ends the coin payout process.

Moreover, the communication control circuit 431 is connected with the CPU 402. This communication control circuit 431 communicates with a communication control circuit 446 composing the later-described second game (i.e., the keno game) control circuit 432, and transmits/receives pieces of information on the insertion/payout of the game media in the second game (i.e., the keno game) to/from the second game control circuit 432.

A second portion enclosed by the broken lines in FIG. 23 is the control circuit 432 of the second game, i.e., the “keno game” of the gaming machine 400. The control circuit 432 includes: a CPU 433 for performing control operations according to the control information transmitted from the gaming machine 500; a ROM 444 and a RAM 445 acting as storage means; and the communication control circuit 446.

The ROM 444 is stored with control programs and various control instructions (or commands) for controlling connection devices connected with the control circuit 432 of the gaming machine 400, that is, a touch sensor 447, a liquid crystal driving circuit 448 and the liquid crystal display 449. Moreover, the ROM 444 is stored with initial data for executing the control programs.

The RAM 445 is stored at the execution time with the body of the aforementioned control programs and temporarily with the values of variables to be used in the control programs.

The various peripheral devices are connected with the CPU 433 through a predetermined group of interface circuits (not-shown).

The touch sensor 447 is connected with the CPU 433. When the operation display displayed in the later-described liquid crystal display is operated by the player, the touch sensor 447 detects the operation and feeds the detection signal to the CPU 433.

Here in this embodiment, the touch sensor 447 constitutes a portion of the “game operation means for operating the game control means of the second game”. However, the invention should not be limited, but the “game operation means for operating the game control means of the second game” may also be configured by detecting the operation of the player with a switch or the line and by feeding the detection signal to the CPU 433.

Moreover, the liquid crystal driving circuit 448 is connected with the CPU 433. When the signal of the information on the display image is fed from the CPU 433 to the liquid crystal driving circuit 448, the signal of the display image is fed to the later-described liquid crystal display 449 on the basis of that signal.

The liquid crystal display 449 is connected with the liquid crystal driving circuit 448. The liquid crystal display 449 receives the signal of the display image fed from the liquid crystal driving circuit 448, and displays that image.

Here in this embodiment, the liquid crystal driving circuit 448 and the liquid crystal display 449 configure the display device of the second game. However, the invention should not be limited thereto, but the display device may also be configured of a CRT (Cathode Ray Tube) display, an EL (Electronic Luminescence) display or a plasma display, for example.

### OUTLINE OF GAMING MACHING 500

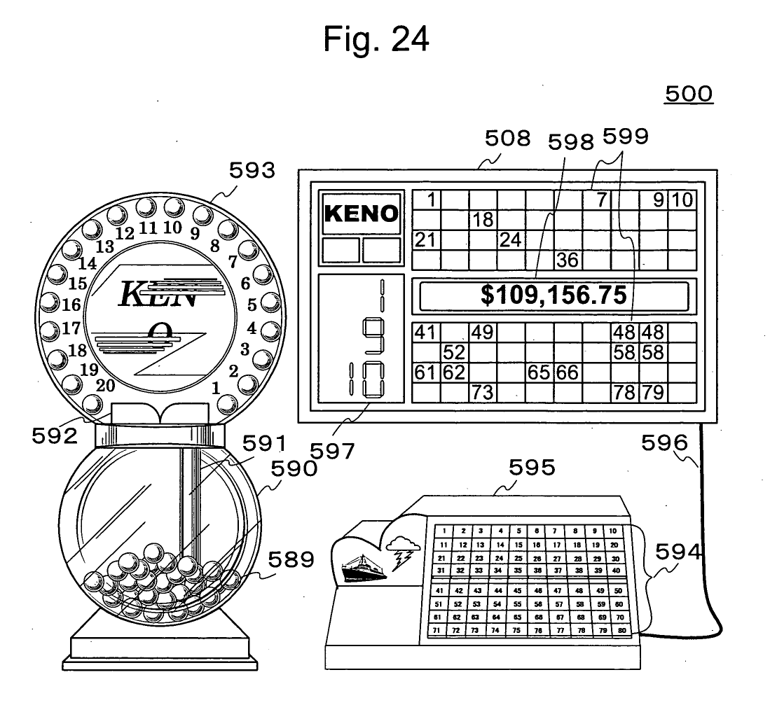

The outline of the gaming machine 500 of this embodiment is shown in FIG. 24.

The gaming machine 500 is a gaming machine for playing the keno game. This gaming machine 500 is configured of three portions: a lottery case 590 for lottery of the keno; a display device 508 electrically independent of the lottery case 590 and made of a seven-segment display; and a numeral input device 595 electrically connected with the display device 508.

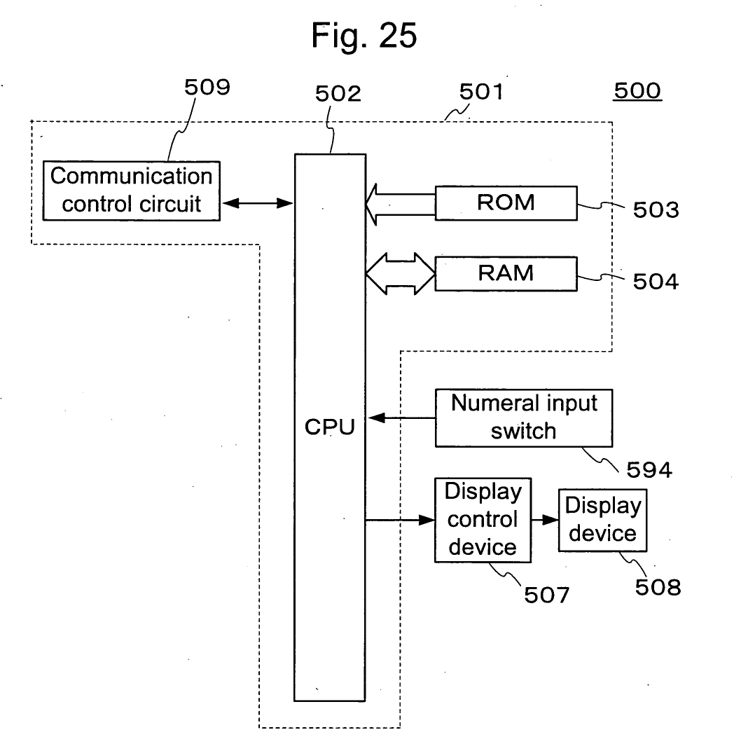

This display device 508 also has a role as the cabinet, which is provided therein with a device corresponding to a main control circuit 501 of FIG. 25.

Balls 589 written with numerals 1 to 80 are contained in the glass container of the lottery case 590. The balls 589 are automatically stirred in the glass container with an electrically stirring rod 591 and are manually drawn one by one for a lottery from a ball take-out mouth 592 so that twenty balls are drawn as a whole. At each lottery, a numeral input switch 594 of the numeral input device 595 corresponding to the numeral written on the ball is operated. The display device 508 is electrically connected with the numeral input device 595 by means of a cable 596 and is provided with winning numeral display 599 indicating the numerals 1 to 80. The winning numeral display 599 of the numeral corresponding to the numerical value input at the numeral input device 595 is lighted to display that numeral. Here, the twenty drawn balls are so fixed one by one in ball fixing holes 593 that their numerals can be viewed on this side.

Moreover, the display device 508 is provided with a award display 598 for displaying the current prize sum.

### ELECTRIC CONFIGURATION OF GAMING MACHINE 500

FIG. 25 is a hardware block diagram of the gaming machine 500.

A portion enclosed by broken lines in FIG. 25 is a main control circuit 501 of the gaming machine 500. The main control circuit 501 configuring second game control means includes: a CPU 502 for performing control operations according to preset programs; a ROM 503 and a RAM 504 acting as storage means; and a communication control circuit 509.

The ROM 503 stores various control programs for controlling the gaming machine 200. Moreover, the ROM 503 stores initial data for executing the control programs, and programs for controlling the displays in the display device 508. Still moreover, the ROM 503 stores various control instructions (or commands) for transmitting signals to the various peripheral devices.

The RAM 504 stores the values of flags and variables to be used in the aforementioned various control programs.

The various peripheral devices are connected with the CPU 502 through a predetermined group of interface circuits (not-shown).

The numeral input switch 594 is connected with the CPU 502 through the interface circuit group. This numeral input switch 594 is operated by the dealer of the keno so that a numeral display signal is fed to the CPU 502 at the switch operating timing.

Moreover, a display control device 507 is connected with the CPU 502. When the display control device 507 receives a numeral display instruction signal from the CPU 502, it controls the display device 508 connected therewith.

### OPERATIONS OF GAMING MACHINE 400

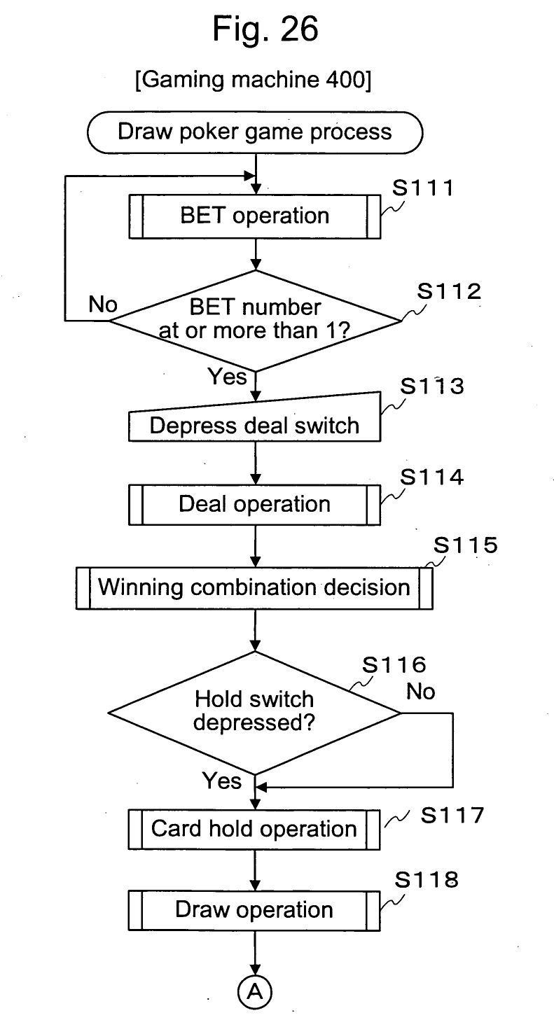

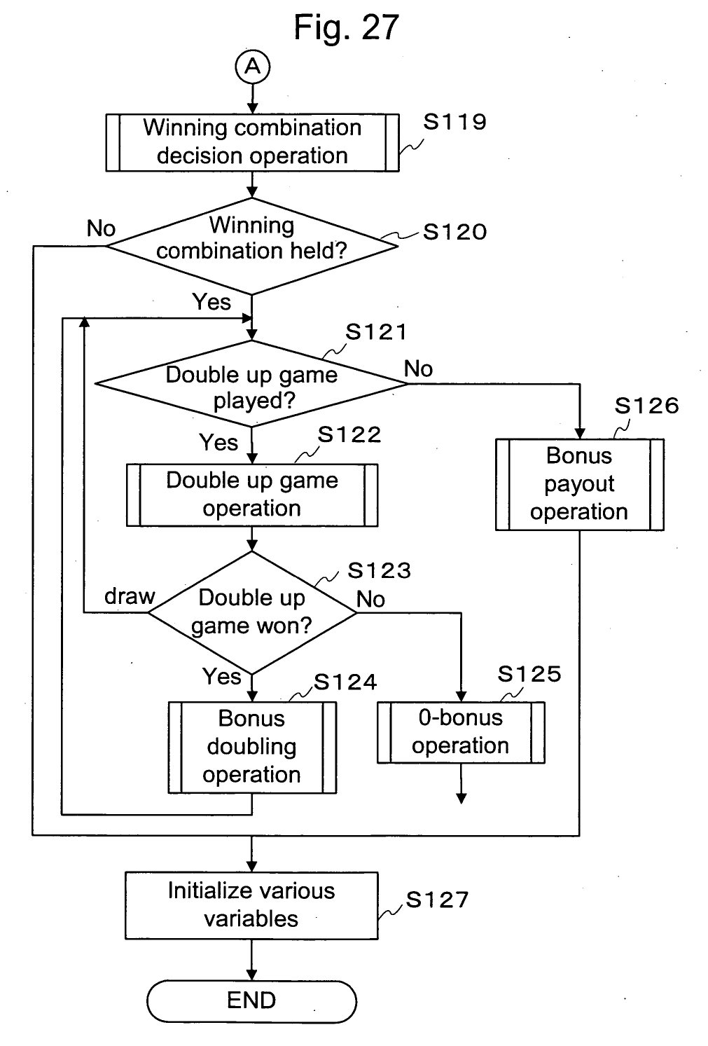

A draw poker process to be executed in the main control circuit 401 of the aforementioned gaming machine 400 for controlling the gaming machine 400 is shown in FIG. 26 and FIG. 27.

Before the following process is performed in the gaming machine 400, it is assumed that the gaming machine 400 is turned on, that the programs for executing the main process are loaded in the RAM 408, and that the individual variables stored in the RAM 408 are initialized.

At Step S111, a BET operation is performed, as shown in FIG. 26. For this operation, a subroutine similar to that of the BET operation shown in FIG. 9 is called. By this operation, the coin number to be bet in the gaming machine 400 by the player is determined. When this operation ends, the subroutine proceeds to the operation of Step S112.

At Step S112, the BET number is determined. By this operation, it is determined whether or not the number of coins bet by the player is at 1 or more. The subroutine proceeds to Step S113, in case the CPU 402 determines that the BET number is at 1 or more, but otherwise returns to Step S111.

Next at Step S113, the DEAL switch is pressed by the player. By this operation, the DEAL switch 413 of the gaming machine 400 detects that the DEAL switch has been pressed by the player, and feeds the detection signal to the CPU 402. After the end of this operation, the subroutine proceeds to Step S114.

Next at Step S114, the DEAL operation is performed. By this operation, the CPU 402 of the gaming machine 400 deals five cards to the player. After the end of this operation, the subroutine proceeds to Step S115.

Next at Step S115, a first winning combination is determined. By this operation, the CPU 402 of the gaming machine 400 determines whether or not the combination of the five cards dealt at the first time to the player corresponds to a poker winning combination. After the end of this operation, the subroutine proceeds to Step S116.

Next at Step S116, the HOLD switch is pressed. The player determines that one or those ones of the five cards dealt at Step S114 which is or are to be held. In case the “HOLD” operation display or displays 498 corresponding to the card or cards to be held is or are touched, the touch sensor 450 detects the touch signal and feeds it to the CPU 402. In case the CPU 402 receives that signal, it proceeds to Step S117. In case the “HOLD” operation display or displays 498 corresponding to the card or cards to be held is or are not touched, the CPU 402 proceeds to Step S118.

Next at Step S117, the card or cards is or are held. In this operation, the card or cards is or are held on the basis of the signal detection of the CPU 402 at Step S116. After the end of this operation, the subroutine proceeds to Step S118.

Next at Step S118, a DRAW operation is performed. By this operation, the CPU 402 of the gaming machine 400 exchanges the card or cards not held at Step S117. After the end of this operation, the subroutine proceeds to Step S119.

At Step S119; a second winning combination is determined, as shown in FIG. 27. By this operation, the CPU 402 of the gaming machine 400 determines whether or not the combination of the five cards after the card exchange for the player corresponds to a poker winning combination. This operation is similar to that of Step S115. After the end of this operation, the subroutine proceeds to Step S120.

Next at Step S120, the result of the winning combination decision of Step S115 or Step S119 is determined. By this operation, the subroutine proceeds to Step S121, in case the CPU 402 of the gaming machine 400 determines that the result of the winning combination decision of Step S115 or Step S119 corresponds to a poker winning combination, but otherwise to Step S127.

Next at Step S121, it is determined whether or not the “DOUBLE UP game” by the player is to be played. This “DOUBLE UP game” is a game to be played by betting the acquirement of the bonus, which has been given to the player when a winning combination held. The victory or defeat of the game is determined by the superiority of the cards, which are drawn by one by both the dealer controlled by the CPU 402 of the gaming machine 400 and the player. The bonus to be acquired by the player is double, in case the card of the player wins, but 0 in case the card of the player loses. It is entrusted to the player whether or not the “DOUBLE UP game” is to be played. In case it is determined by the operation of the control panel that the player plays the “DOUBLE UP game”, the subroutine proceeds to Step S122. Otherwise, the subroutine proceeds to Step S126.

Next at Step S122, the DOUBLE UP game operation is performed. After the end of this operation, the subroutine proceeds to Step S123.

Next at Step S123, the result of the DOUBLE UP game at Step S122 is determined. In this operation, the CPU 402 of the gaming machine 400 determines the DOUBLE UP game of Step S122. The subroutine proceeds to the operation of Step S124, in case the player wins, and to the operation of Step S125, but returns to Step S121 in the drawn case.

Since the player won in the DOUBLE UP game at Step S123, the CPU 402 of the gaming machine 400 doubles the bonus of the player at Step S124. After the end of this operation, the subroutine returns to Step S121.

Since the player lost in the DOUBLE UP game at Step S123, the CPU 402 of the gaming machine 400 sets the bonus to 0 at Step S125. After the end of this operation, the subroutine proceeds to Step S127.

At Step S126, on the other hand, the bonus is paid out. In order to give the player the bonus corresponding to the poker winning combination, the CPU 402 of the gaming machine 400 credits the coins corresponding to the bonus. For the coins exceeding the maximum credit number, the CPU 402 of the gaming machine 400 feeds the coin payout signal to the hopper driving circuit 417. In response to this signal, the hopper driving circuit 417 drives the hopper 418 to pay out the coins from the coin payout opening 496. At this time, the coin detection 420 counts the number of coins paid out from the coin payout opening 496. In case the coin detection unit 420 detects that the coins have reached a predetermined number, it feeds the payout signal completion circuit 419 with the signal to stop the payout of the coins, so that the payout signal completion circuit 419 feeds the CPU 402 with the signal to stop the payout of the coins. The CPU 402 fed with that signal feeds the hopper driving circuit 417 with the signal to stop the payout of the coins. After the end of this operation, the subroutine proceeds to Step S127.

Next at Step S127, the various variables are initialized. The CPU 402 of the gaming machine 400 initializes the various variables arranged in the RAM 408. After the end of this operation, this subroutine ends.

### OPERATIONS OF GAMING MACHINE 500

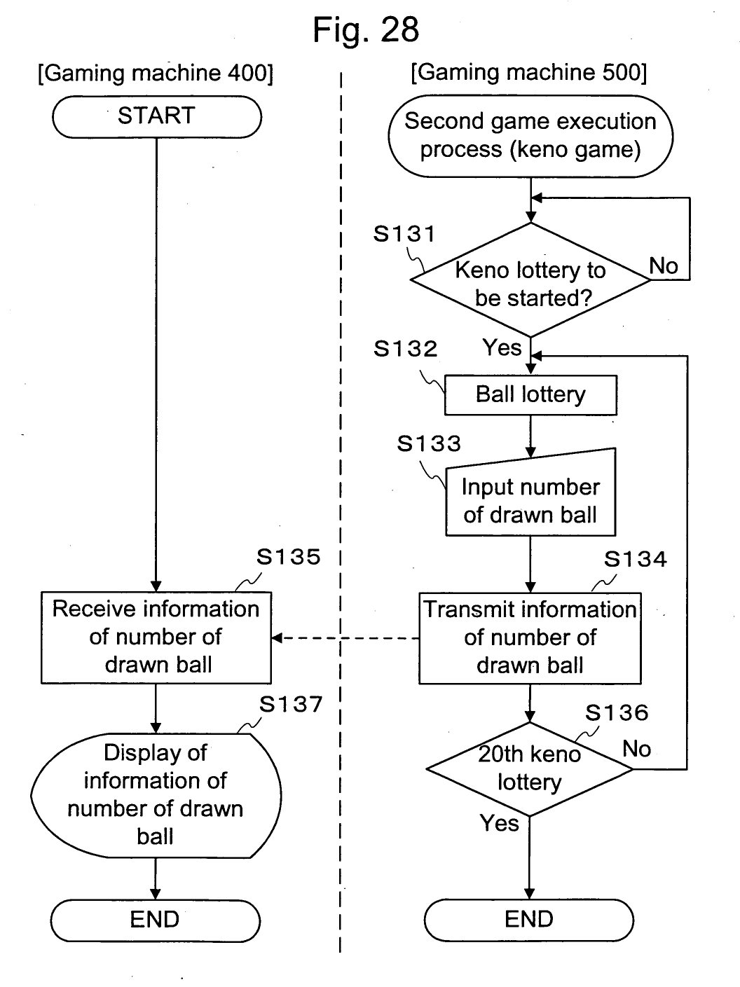

The operations of the gaming machine 500 of the third embodiment are similar to those of the first and second embodiments. Since the subroutine to be called in the second game execution process in FIG. 13 is different, however, the execution process of the second game (i.e., the keno game) will be described with reference to FIG. 28.

First of all in the gaming machine 500, the subroutine proceeds to Step S132, in case it is determined at Step S131 that the keno lottery is to be started by the dealer. Otherwise, the operation of Step S131 is executed again.

Next at Step S132, the keno lottery is drawn by the dealer. After the end of this operation, the subroutine proceeds to Step S133.

Next at Step S133, the number of the drawn ball is input. The numeral input switch 594 of the numeral input device 595 is operated by the keno dealer so that the winning numeral display 599 of the display device 508 corresponding to the switch of the operated numeral is lighted. After the end of this operation, the subroutine proceeds to Step S134.

Next at Step S134, that information on the number of the ball lighted at the winning numeral display 599 of the display device 508, which has been input at Step S133, is converted into a signal, and this signal is transmitted to the gaming machine 400. The CPU 502 of the gaming machine 500 converts that information on the ball number into a signal, and transmits the signal to the gaming machine 400 through the communication control circuit 509. After the end of this operation, the subroutine in the gaming machine 500 proceeds to Step S136.

At Step S135 of the gaming machine 400, on the other hand, that signal of the information on the ball number, which has been transmitted at Step S134 of the gaming machine 500, is received. When the communication control circuit 446 of the gaming machine 400 detects the reception of that signal, it feeds the detection signal to the CPU 433. When this operation ends, the subroutine in the gaming machine 400 proceeds to Step S137.

Next at Step S137, the number of the drawn ball is displayed. In this operation, on the basis of the detection signal of the signal of the information on the ball number fed at Step S135 to the CPU 433, this CPU 433 feeds the liquid crystal driving circuit 448 with the display instruction signal of that information. The liquid crystal driving circuit 448 fed with that instruction signal causes the liquid crystal display 449 to display the number of the drawn ball. When this operation ends, the subroutine ends in the gaming machine 400.

At Step S136 of the gaming machine 500, on the other hand, it is determined whether or not the lottery of the keno has reached twenty times. In other words, the operations of Step S132 to Step S134 are repeated till the keno lottery reaches the twenty times. When the keno lottery the twenty times, this subroutine is ended.

### DISPLAY ON SECOND DISPLAY DEVICE OF GAMING MACHINE 400 IN THIRD EMBODIMENT

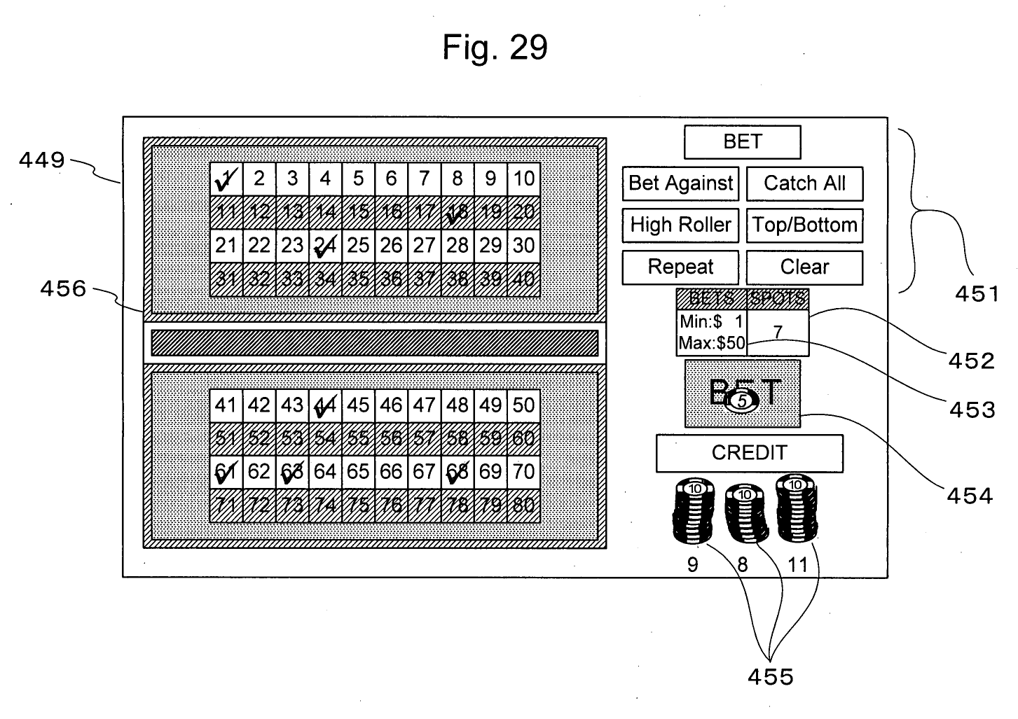

FIG. 29 is a display image diagram of the second game (i.e., the keno game) of the third embodiment displayed in the second display device of the gaming machine, i.e., in the liquid crystal display 449.

An operation display 456 is a display for displaying the numerals of the keno to be selected by the player. When the player touches the section of the numeral to be selected, the “check mark” is displayed in the section of the numeral selected. Moreover, the lottery of the keno is performed, and the section of the numeral of the winning number is reversely displayed so that it can be discriminated from the remaining sections.

An operation display 451 is a touch portion for selecting the various BET methods in the keno. When the player touches the operation display corresponding to the BET method to be selected, the BET method is activated with the corresponding operation display being reversed.

A display 452 displays the number of numerals selected by the player.

A display 453 displays the range of the numbers of coins, which can be bet by the player.

A display 454 displays the number of the coins bet by the player. The player is enabled to bet the coins by dragging the coins one by one through the touch from the display of the coins located below the display of CREDIT, to the display 453.

An operation display 455 displays the CREDIT number of coins visually. The CREDIT number in this display is equal to the CREDIT number displayed in the CREDIT number display device of the gaming machine 400.

By thus configuring the gaming machines to perform those operations, the player of the video poker game is enabled at the video poker gaming machine to participate in the keno game without moving to the keno game table installed at another place.. As a result, the participation of the video poker player in the keno game can be promoted to improve the selectivity of the game by the video poker game player thereby to enhance the working efficiency of the entire gaming place. Moreover, it is possible to provide opportunities for more players to participate in the keno game.

### OTHER MODIFIED EMBODIMENTS

In the first, second and third embodiments thus far described, the combination has been made either between the slot for the first game and the horse racing game or the roulette for the second game or between the poker for the first game and the keno for the second game. However, the invention should not be limited to those combinations, but can also be practiced by combining the first game and the second game freely. For example, the game should not be limited to the slot, the video poker, the horse racing, the roulette or the keno, but may be another game such as mahjong, blackjack, Japanese playing cards, bingo, or baccarat. Any two of these games can be selected and combined to practice the invention. Then, any game may correspond to either the first game or the second game.

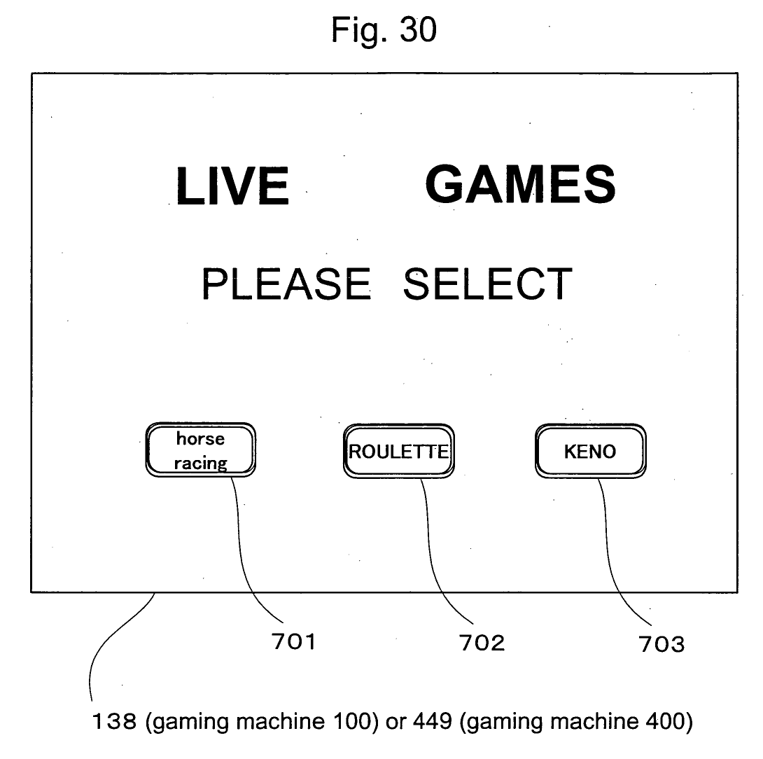

In the first, second and third embodiments, moreover, what is incorporated into one gaming machine is one second game. However, the invention should not be limited thereto, but the second game may also be selected from among a plurality of games. In the liquid crystal display 138: as the second display device of the gaming machine 100 or in the liquid crystal display device 449 as the second display device of the gaming machine 400, for example, the screen shown in FIG. 30 is displayed so that a plurality of second games may be selected. In FIG. 30: the horse racing game can be executed if an operation display 701 is touched; the roulette can be executed if an operation display 702 is touched; and the keno can be executed if an operation display 703 is touched.

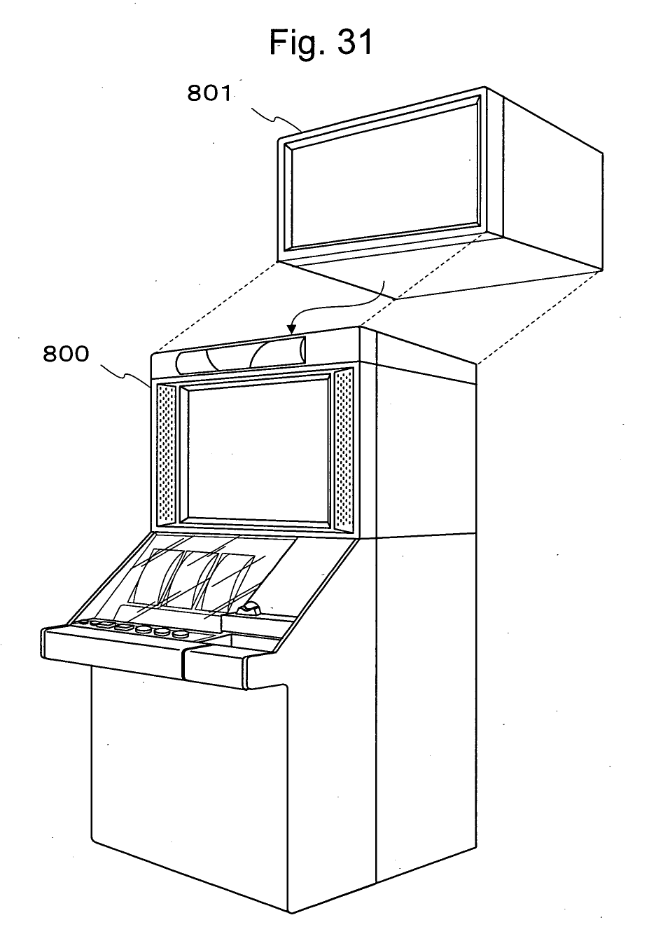

In the first, second and third embodiments, moreover, the cabinet of the gaming machine 100 and the gaming machine 400 has the upright shape. However, the invention should not be limited thereto, but can also be applied to an upright cabinet 800 shown in FIG. 31. Then, a system component 801 for the second game is physically additionally arranged on the slanted cabinet.

According to the invention, the player of the first game is enabled to participate in the second game without moving to the gaming machine installed at another place. As a result, the selectivity of the game by the player can be improved to enhance the working efficiency of the entire gaming place.

1. A gaming system comprising:
a first gaming machine for providing a first game, which includes a control panel to be operated by a first player; and a second gaming machine connected communicatively with the first gaming machine for providing a second game, which is different from the first game and in which another player in addition to the first player is capable of participating,
wherein the second gaming machine comprises second game control means including: program storage means for storing a program to control the second game; program execution means for executing the program; image data storage means for storing image data of the second game; and image data transmission means for transmitting the image data of the second game to the first gaming machine, and
wherein the first gaming machine comprises: first game control means for controlling the first game; image data reception means for receiving the image data of the second game transmitted from the second gaming machine; second display means for displaying an image based on the image data of the second game; and game operation means for operating the game control means of the second game.

2. The gaming system according to claim 1, wherein the first player operates the game operation means such that the first player bets for the second game.

3. The gaming system according to claim 1, wherein the first gaming machine comprises payout means for paying out to the first player based on a result of the second game.

4. The gaming system according to claim 1, wherein the first game is played only by the first player.

5. The gaming system according to claim 1, wherein the first gaming machine comprises first display means for variably displaying a plurality of symbols for the first game.

6. The gaming system according to claim 1, wherein the first gaming machine comprises a video poker game.

7. The gaming system according to claim 1, wherein the first and second gaming machines are connected through the Internet.

8. The gaming system according to claim 1, wherein the second gaming machine transmits a starting signal to the first gaming machine such that the first player is invited to the second game.

9. A first gaming machine for providing a first game, which includes a control panel to be operated by a first player;
wherein the first gaming machine is connected communicatively with a second gaming machine for providing a second game, which is different from the first game and in which another player in addition to the first player is capable of participating, and
wherein the first gaming machine comprises: first game control means for controlling the first game; image data reception means for receiving the image data of the second game transmitted from the second gaming machine; second display means for displaying an image based on the image data of the second game; and game operation means for operating game contents of the second game.

10. The first gaming machine according to claim 9, wherein the first player operates the game operation means such that the first player bets for the second game.

11. The first gaming machine according to claim 9, wherein the first gaming machine comprises payout means for paying out to the first player based on a result of the second game.

12. The first gaming machine according to claim 9, wherein the first game is played only by the first player.

13. The first gaming machine according to claim 9, further comprising first display means for variably displaying a plurality of symbols for the first game.

14. The first gaming machine according to claim 9, wherein the first gaming machine comprises a video poker game.

15. The first gaming machine according to claim 9, wherein the first gaming machine is connected with the second gaming machine through the Internet.

16. The first gaming machine according to claim 9, wherein the first gaming machine receives a starting signal from the second gaming machine such that the first player is invited to the second game.
